(19) United States
(12) Patent Application Publication
(10) Pub. No.: US 2012/0298449 A1
(43) Pub. Date: Nov. 29, 2012

(54) SCAFFOLD AND METHODS FOR INSTALLING OR REMOVING SUCH A SCAFFOLD

(75) Inventor: Helmut Kreller, Bad Rappenau (DE)

(73) Assignee: WILHELM LAYHER VERWALTUNGS-GMBH, Gueglingen-Eibensbach (DE)

(21) Appl. No.: 13/376,251

(22) PCT Filed: Dec. 1, 2010
(86) PCT No.: PCT/DE10/75148

§ 371 Date: Dec. 5, 2011

(30) Foreign Application Priority Data
Feb. 19, 2010 (DE) 10 2010 000 472.3

(51) Int. Cl. E04G 1/14; B23P 11/00; E04G 5/14

(52) U.S. Cl. 182/113; 29/428; 29/426.1

(57) ABSTRACT

A scaffold and method(s) for installing or removing such a scaffold that is constructed of at least two vertical frames and of at least two connecting elements that extend essentially horizontally, in each instance, includes at least one connecting element serving as a hip and/or back railing element, vertical supports having respective effective lengths essentially corresponding for example to the vertical distance of the attachment position for the hip and/or back railing element, and horizontal arms set onto one another to form transverse rungs, in each instance, of a ladder for allowing a person to climb up.

The invention relates to a scaffold, particularly a falsework or load-bearing scaffold, preferably a load-bearing scaffold tower, falsework tower or load-bearing tower, if applicable a work scaffold, façade scaffold, or mobile scaffold, that is constructed of at least two vertical frames, and of at least two or at least four connecting elements that extend essentially horizontally, in each instance, preferably also of at least two vertical diagonals that reinforce the scaffold, preferably with the formation of a polygonal, particularly rectangular or square layout, having the following characteristics:
a) at least one vertical frame of the vertical frames is set onto a vertical frame of the vertical frames, whereby a vertical frame arrangement is configured in the form of a vertical frame support;
b) the vertical frames of the vertical frame support comprise at least two, preferably precisely two parallel vertical supports, in each instance, which are disposed at a horizontal distance from one another;
c) the vertical frames of the vertical frame support comprise at least two, preferably precisely two parallel horizontal struts, in each instance, which are disposed at a vertical distance from one another;
d) the horizontal struts of the vertical frames of the vertical frame support extend, in each instance, between the at least two vertical supports of the vertical frame, in each instance, perpendicular to these vertical supports, and are attached to them, with their ends, by means of welding;
e) the particularly straight, preferably continuous, particularly rigid, preferably configured as connecting rods, particularly with a scaffold pipe, in each instance, connecting elements extend, in each instance, between a vertical support of a or the respective vertical frame of the vertical frames, and at least one further vertical support disposed at a horizontal distance from it, and are releasably attached, with their ends, on attachment positions of these vertical supports;
f) floor plates can be affixed or are affixed on attachment positions, preferably on at least one connecting element of the connecting elements and/or on the respective vertical frame of the vertical frame support, particularly on a horizontal arm of the horizontal arms of the respective vertical frame of the vertical frame support, in vertical regions of the scaffold that are provided vertically one on top of the other, in tier-type manner.

The invention also relates to a method for installing and/or removing such a scaffold.

Such a scaffold and such a method for installing and/or removing such a scaffold have become known, for example, from WO 2009/092340 A1 and a related brochure “Schnell. Flexibel. Intelligent. Layher Allround Lehrgerüstturm [Fast. Flexible. Intelligent. Layher Allround falsework tower],” edition Jan. 1, 2009. Such falsework towers belong to the so-called falseworks or load-bearing scaffolds. In part, load-bearing scaffolds are also referred to as falseworks, and vice versa, whereby the term falsework is a very old name. Load-bearing scaffolds are particularly understood to be non-permanent, in other words only temporary constructions made of steel or wood, having a comparatively short useful lifetime and a great frequency of use. They are put together from multiple individual components, for the purpose of use, in each instance, and are taken apart again after they have fulfilled their intended purpose. Load-bearing scaffolds serve to carry away great vertical loads. In this connection, these are generally supporting loads and/or concrete-work loads during the construction phase. Load-bearing scaffolds therefore serve, for example, for supporting temporary steel structures, props, surrounds, or concrete-work loads during concrete work, as long as the concrete is not yet capable of bearing a load. In this case, the load-bearing scaffold must carry not only the weight of the concrete but also the inherent weight of the forms and the traffic loads during concrete work. Load-bearing scaffolds therefore serve for temporary support, underneath or to the sides, of forms for fresh concrete as well as of components made of steel, wood, or finished parts. The loads to be absorbed by load-bearing scaffolds are great, in comparison with the inherent weight of the load-bearing scaffold.

Falseworks or load-bearing scaffolds can be constructed in the form of one or more towers coupled with one another by means of connecting elements, in other words as load-bearing scaffold towers or falsework towers. In this connection, generally multiple modular modules having the same or a similar structure are disposed one on top of the other in level or height blocks, and fixed in place against one another in this connection. For this purpose, steel pipe rod support structures are generally used nowadays. In this connection, the vertical supports of the vertical frames, in each instance, which are also referred to as posts and generally consist of steep pipes, are connected with one another by way of coupling elements. In general, two vertical frames that are the same and spaced horizontally apart are used per height block or level, in each instance; these are particularly connected with one another by way of diagonal struts that are horizontally spaced apart, and reinforced relative to one another. In this connection, so-called cross diagonals or diagonal crosses, consisting of two intersecting diagonals that span a common vertical plane, can also be used.

Load-bearing scaffolds generally have a square or rectangular layout, i.e. the two vertical frames that span a vertical frame plane and are horizontally spaced apart, in each instance, are connected with one another by way of releasable diagonals that extend perpendicular to the vertical frame plane, if necessary also by way of additional releasable horizontal struts, forming such layouts. In this manner, a rod support structure is obtained per height block or per level, which structure is delimited laterally by rods that span four vertical planes, whereby adjacent vertical planes stand perpendicular to one another.

When constructing load-bearing scaffolds having a square layout, the two vertical frames per height block or level are frequently disposed offset by 90 degrees relative to one another. However, it is also possible to dispose the vertical frames of each height block or level not offset from one another, i.e. vertically one above the other.

Such load-bearing scaffolds constructed from pre-finished, closed vertical frames can be set up and taken down again in clearly understandable, simple, and fast manner. Because of the comparatively small number of basic components required per height block, handling and transport of such load-bearing scaffolds can also be implemented in simple and cost-advantageous manner.

The diagonals that connect the vertical frames are predominantly connected with the posts or with the vertical frames either by way of horizontal cross-bolts that are provided with tilt pins and welded onto the posts of the vertical frames, onto which bolts their perforated ends are set, or by way of engagement claws attached to their ends, which are releasably engaged into one of the horizontal struts of the vertical frames, in each instance. In the case of the falsework towers that are evident from the two aforementioned references, the diagonals that connect the vertical frames can be or are wedged in place on perforated disks that are welded in place on the vertical supports of the vertical frames, by way of connecting heads articulated on at both ends, by means of connecting wedges.

For standing installation of these falsework towers, as well as for later ascent to the underside of the ceiling boarding, floor plates, for example in the form of so-called O steel floors, can be laid in the falsework tower. These steel floors have two suspension hooks, at both ends, in each instance, suitable for being laid onto round pipes, by means of which the steel floors can be laid onto or suspended on horizontal bars configured as round pipes. The horizontal bars form connecting elements that extend horizontally between the horizontally adjacent vertical supports of the vertical frames disposed laterally or on the face side, as well as parallel to one another, and which are releasably attached there, on the perforated disks of the vertical supports of the vertical frames, by way of their connecting heads provided on both ends. For example, the following vertical frames can be provided for constructing these falsework towers, which comprise multiple height blocks:

Two so-called equalization frames, in each instance, can be disposed at a horizontal distance from one another and at the same height; these frames can be parts, in each instance, of a bottommost height block and of an uppermost height block. Each of these equalization frames or each of its vertical supports, respectively, have an effective length of 70.9 cm. Each of these equalization frames has precisely two horizontally spaced apart, parallel vertical supports, and precisely two parallel horizontal arms, which are disposed at a vertical distance of 50 cm from one another and are firmly welded onto the vertical supports, perpendicular to them, in each instance.

Multiple height blocks can be provided between the lowermost height block formed with the equalization frame and the uppermost height block formed with the equalization frame, or also without such equalization frames, which blocks are constructed from two vertical frames, in each instance, referred to as “normal frames” or as “standard frames” having a horizontal distance from one another and disposed essentially at the same height. Each of these “standard frames” of each of its vertical supports has an effective length of 150 cm or more, for example about 176 cm. Each of these equalization frames has precisely two horizontally spaced apart, parallel vertical supports, and also has precisely two parallel horizontal arms, which are disposed at a vertical distance of 130 cm or more, for example about 156 cm from one another and are firmly welded onto the vertical supports, perpendicular to them, in each instance.

If floor plates are disposed in the height blocks that lie one on top of the other, in tier-type manner, the horizontal bars of a height block that are provided as connecting elements between the two horizontally spaced-apart “standard frames,” in each instance, provided at essentially the same height per height block, or the floor plates of a next tier that are laid onto them, have a vertical distance of about 150 cm or more, for example about 176 cm, from the adjacent floor plates of the height block that lies underneath or the tier that lies underneath.

For standing installation of the falsework towers, as well as for later ascent to the underside of the ceiling boarding—from one tier to the next tier or from one platform to the next platform—a special, separate suspension ladder is used. This suspension ladder has a suspension hook, in each instance, at the upper ends of its two ladder uprights, for hanging the ladder onto a horizontal bar of a next tier. In this suspended state, the ladder supports itself, with the lower ends of its ladder uprights, on two horizontally directly adjacent floor plates of the lower tier. This standing installation and also the ascent as well as descent are an accident risk, and no longer satisfy the current safety requirements.

It is therefore the task of the invention to make available a scaffold and method(s) for installing and/or removing such a scaffold, in which the accident risk during standing installation or standing removal is reduced to a minimum, the individual parts of which have a comparatively low weight, and in which installation and/or removal can be carried out efficiently, in simple manner.

This task is accomplished by means of the characteristics of claims 1, 14, and 22. In particular, this task is accomplished, in the case of a scaffold having the characteristics indicated above, by means of the following characteristics:
g) at least one connecting element of the connecting elements serves, at least during installation of the scaffold, if applicable also on the finished, constructed scaffold, and/or during removal of the scaffold, as a hip and/or back railing element, to protect a person from falling down to the side, if applicable also as a floor plate support element for supporting at least one floor plate of the floor plates;
h) the vertical supports of the vertical frames have an effective length, in each instance, which essentially corresponds to the vertical distance of the attachment position for the hip and/or back railing element, or for the floor plate from the attachment position for the hip and/or back railing element, or for the floor plate of a vertical frame of the vertical frames that already belongs to the next vertical region and is already set onto the vertical frame of the vertical region that lies underneath, or which is smaller than this vertical distance;
i) the horizontal arms of the vertical frames of the vertical frame support, which are set onto one another, form transverse rungs, in each instance, of an ascent device or ladder, preferably containing at least four transverse rungs, for allowing a person to climb up, whereby the uppermost transverse rung of a vertical frame of the vertical frames has a vertical rung distance, from the bottommost transverse rung of the vertical frame that already belongs to the next vertical region, and is already set onto the vertical frame of the vertical frames of the vertical region that lies underneath, that essentially corresponds to the vertical distance between the transverse rungs of the individual vertical frames, so that all the adjacent transverse rungs of the ladder essentially have the same vertical transverse rung distances relative to one another;
k) preferably, the hip and/or back railing element can be guided upward from a vertical region of the scaffold, which has already been completed, to the attachment position of a vertical frame that already belongs to the next vertical region of the scaffold, already set onto the assigned vertical frame of the vertical region that lies underneath, by a person standing on a floor plate of the already completed vertical region or on the ground, and can be fixed in place there, on the attachment position of the vertical frame that has been set on, and on the attachment position of the further vertical support.

By means of these measures, a particularly secure standing installation and/or removal of the scaffold can be implemented, whereby a side protection is possible by means of at least one leading, preferably circumferential hip and/or back railing. During face-side or same-side installation of the vertical frames according to the invention onto or on top of one another, an integrated ascent and, if applicable, descent possibility in the form of a ladder is automatically formed. Using this integrated ladder, persons can safely climb up or climb down, by way of the ladder, during installation and/or removal of the scaffold, and therefore be optimally protected within the scaffold construction, to prevent them from falling down, during or for the purpose of installation and/or removal of the leading hip and back railing, as well as in the finished, set-up scaffold.

If the vertical frame, in each instance, is structured with only two transverse rungs, the weight and the costs can be minimized accordingly. It is understood, however, that the vertical frames, in each instance, can also be configured with more than two transverse rungs, for example with three or four transverse rungs.

The above advantages can be implemented to a particular degree, in the case of a scaffold according to the invention, if the following characteristics are implemented:
a) the scaffold comprises at least four vertical frames;
b) at least two of the vertical frames are disposed at essentially the same height and at a horizontal distance from one another, and form part of a height block of the scaffold;
c) at least two others of the vertical frames are set onto the vertical frame of the height block, at essentially the same height and at a horizontal distance from one another, and form a part of a next height block, so that at least two vertical frame arrangements, in the form of a vertical frame support, in each instance, are formed, which are disposed at a horizontal distance from one another;
d) the vertical frames of at least one vertical frame arrangement of the vertical frame arrangements, which frames are set onto one another, preferably the at least four vertical frames of the vertical frame arrangements, comprise at least two, preferably precisely two parallel vertical supports, in each instance, which are disposed at a horizontal distance from one another;
e) the vertical frames of at least one vertical frame arrangement of the vertical frame arrangements, which frames are set onto one another, preferably the at least four vertical frames of the frame arrangements, comprise at least two, preferably precisely two parallel horizontal struts, in each instance, which are disposed at a vertical distance from one another;
f) the horizontal struts of the horizontal frames of the vertical frame arrangements extend, in each instance, between the at least two vertical supports of the vertical frame, in each instance, perpendicular to these vertical supports, and are attached to them, with their ends, by means of welding;
g) the connecting elements, which are particularly straight, preferably continuous, particularly rigid, preferably configured as connecting rods, particularly with a scaffold pipe, in each instance, extend, in each instance, between adjacent vertical supports of the vertical frames of the height block, in each instance, and are releasably attached, with their ends, to attachment positions of these vertical supports;
h) the vertical supports of the at least four vertical frames have an effective length, in each instance, that essentially corresponds to the vertical distance of the attachment position for the hip and/or back railing element, or for the floor plate from the attachment position for the hip and/or back railing element, or for the floor plate of a vertical frame of the vertical frames that already belongs to the next vertical region and is already set onto the vertical frame of the vertical region that lies underneath, or which is smaller than this vertical distance.

In this connection, it can be particularly advantageous if the following additional characteristics are provided:
a) the horizontal arms of the vertical frames of the at least two vertical frame arrangements, which are set onto one another and are horizontally spaced apart, form transverse rungs, in each instance, of an ascent or descent aid or ladder;
b) the uppermost transverse rung of a vertical frame of the vertical frames has a vertical transverse rung distance, from the bottommost transverse rung of a second vertical frame of the vertical frames, that already belongs to the next vertical region or height block, and is already set onto the vertical frame of the vertical region that lies underneath, that essentially corresponds to the vertical distance between the transverse rungs of the individual vertical frames, so that all the adjacent transverse rungs of the ladder, in each instance, essentially have the same vertical transverse rung distances relative to one another.

The scaffold or the vertical frames according to the invention can have the following additional characteristics, in a particularly advantageous embodiment:
a) a first horizontal arm of the horizontal arms of the vertical frame, in each instance, is attached in the region of the upper or lower end of the vertical supports of the vertical frame;
b) a second horizontal arm of the horizontal arms of the vertical frame, in each instance, is attached in the region of the vertical center of the vertical supports of the vertical frame.

In this way, particular advantages can be implemented during installation or removal, particularly of the leading hip and/or back railing, if applicable also in connection with particularly advantageous possibilities for integration and positioning of connecting elements in a raster dimension of a modular scaffold.

In another advantageous embodiment, it can be provided that at least two connecting elements of the connecting elements, disposed essentially at the same height, serve as protection at least during installation of the scaffold, if applicable also in the finished, constructed scaffold and/or during removal of the scaffold, as a hip and/or back railing element, in each instance, for protection to prevent a person from falling down to the side, if applicable also as a floor plate support element, in each instance, to support at least one floor plate of the floor plates. In this way, in combination with the vertical frames according to the invention, a leading or fore-running, circumferential hip and/or back railing and consequently a circumferential side protection can be implemented.

In a further improved embodiment, it can be provided that the vertical supports of the vertical frames that are set onto one another can be separated from one another in the region, preferably directly or shortly or at a slight distance, above or below, of the attachment position of the connecting element of each vertical region, in each instance. In this way, the possibilities for particularly simple installation or installation of a leading hip and/or back railing can be further improved.

In a further improved embodiment, the vertical frames according to the invention can be structured to be symmetrical to their center vertical axis. As a result, it is not necessary to pay attention to installation on the correct side when the vertical frames are installed. In contrast to this, in the “standard frames” used until now, attention always had to be paid to installation of the vertical frames on the correct side, because of the vertical diagonals that were provided there on one end, in the region of an upper end of a vertical support of the “standard frame,” in each instance, and at the other end, in the region of a lower end of a second vertical support of this “standard frame,” extending between them and welded to them, particularly for reasons of static calculations. Accordingly, when using the “symmetrical” vertical frames according to the invention, simpler and faster installation is possible than before.

In a particularly advantageous embodiment, it can be provided that the effective length of the vertical frame according to the invention or of the vertical frames according to the invention or of their vertical supports amounts to between 80 cm and 120 cm, preferably about 100 cm. With such vertical or standard frames, it is possible to implement a leading hip and/or back railing, which has a vertical distance from the at least one floor plate of the vertical region or vertical section that lies underneath, of also about 80 cm to 120 cm, particularly of about 100 cm, in every vertical region or vertical section of the scaffold that can be equipped or is equipped with at least one floor plate, in tier-type manner, in particularly fast, simple, and safe manner. In the region of this railing height, optimal hip and/or back side protection is made possible. It is understood that the said effective length can also be smaller than 80 cm, particularly can amount to about 30 to 70 cm, preferably about 50 cm.

Preferably, it can be provided that the transverse rung distance amounts to about half the effective length of the vertical frames and/or about 40 to 60 cm, preferably about 50 cm or about 15 to 35 cm, preferably about 25 cm. This allows a ladder that allows convenient, i.e. simple and fast ascent or descent of persons. Furthermore, in this way, multiple floor plates can be affixed at a corresponding slight distance or in a corresponding raster dimension, one on top of the other, either in a direction, preferably parallel, to the hip and/or back railing elements or in the longitudinal direction, or, if applicable, also offset from one another by 90 degrees about a vertical axis of the scaffold. This allows great flexibility while or for the purpose of constructing different scaffold structures and/or transition or connection configurations, if applicable also adapted to a raster dimension of a modular scaffold, particularly of the Layher Allround modular scaffold, all the way to a spiral-staircase-type structure of the floor plates. It is understood that floor plates can also be installed floor with pass-through or pass-through scaffold floors, particularly in a direction, preferably parallel, to the hip and/or back railing elements or in the longitudinal direction, so that the scaffold can also be used as an “access.”

Furthermore, it can be provided that at least one, particularly a single transverse rung of the transverse rungs of the vertical frame, in each instance, preferably a transverse rung disposed in the region of the vertical center of the vertical frame, in each instance, is reinforced by means of two corner reinforcement elements, preferably corner reinforcement rods, that extend diagonally, in each instance, between the transverse rung and, in each instance, one of the vertical supports of this vertical frame, and upward or downward, in each instance, from the transverse rung, preferably whereby the corner reinforcement elements are attached, with their ends, not only to the transverse rung but also to the vertical frame, in each instance, by means of welding. The vertical frame, in each instance, can advantageously be reinforced by means of these corner reinforcement elements. It is understood that alternatively or in addition, corner reinforcement elements disposed to run diagonally, particularly symmetrical to the vertical center axis of the vertical frame, can be provided between the transverse rungs and attached there by means of welding. In other words, the corner reinforcement elements do not have to be attached to a vertical support of the vertical frame. Because of an arrangement of the corner reinforcement elements symmetrical to a vertical center axis of the vertical frame, installation of the frame on the correct side is not important, thereby making it possible to carry out the installation easily and quickly. Furthermore, by means of the configuration and placement of these corner reinforcement elements, the result can be achieved that when persons climb up or down, these corner reinforcement elements do not cause a hindrance, particularly in the form of so-called tripping traps, or that these are avoided.

Furthermore, it can be provided that the vertical supports of the vertical frames have been coupled or are coupled with one another by way of plug-in connections, to form the vertical frame support or the vertical frame arrangement. This allows particularly simple and fast installation and removal. In this connection, it can be provided that the vertical supports of the vertical frames have a push-on element or a plug-in element, particularly a pipe connector, at one end of their ends, in each instance, preferably at a lower end, in each instance, by means of which the vertical supports of a vertical frame have been or are set onto the vertical supports of another vertical frame, preferably whereby the push-on element or plug-in element can be connected with the vertical support in non-releasable manner, particularly in one piece, preferably produced by means of reshaping the vertical support, in each instance. Alternatively, the push-on element or the plug-in element can also be connected with the vertical support in multiple parts, in each instance, preferably attached to the vertical support, in each instance, by means of a press-fit connection. Using vertical frames configured in this manner, the result can be achieved that the scaffold can be installed or removed without screws and/or without a wrench, if applicable only using a hammer.

It can be very particularly advantageous if, in the case of a scaffold according to the invention, or if, in the case of the vertical frames according to the invention, the following additional characteristics are provided:
a) a perforated disk provided with multiple perforations, particularly disposed concentric to the vertical support and surrounding the vertical support in flange-like manner, is attached, in each instance, in non-releasable manner, preferably by means of welding, for connecting holding devices, particularly for suspending support and/or connecting elements, preferably of scaffold elements that run horizontally and/or diagonally, for example scaffold bars and/or scaffold diagonals, particularly of a modular scaffold, on at least two of the vertical supports, preferably on the vertical supports that are disposed farthest to the outside, particularly on all the vertical supports, preferably in the region of the lower end, in each instance, or the upper end, in each instance, of the vertical supports of the vertical frame, in each instance;
b) at least one transverse rung of the transverse rungs of the vertical frame or the respective vertical frame, preferably the bottommost or uppermost transverse rung of the transverse rungs of the vertical frame or the respective vertical frame, comprises a, preferably a single, particularly a straight horizontal strut that is connected, at its ends that face away from one another, in one piece or in multiple pieces, in each instance, with a connecting head;
c) the connecting head, in each instance, of the transverse rung is delimited with side wall parts that have vertical outer surfaces that run towards a center, preferably a post center and disk center of the related perforated disk, in wedge-like manner, which surfaces enclose a wedge angle that amounts particularly to 40 degrees to 50 degrees, preferably about 45 degrees, particularly 44 degrees;
d) the connecting head, in each instance, of the transverse rung has an upper head part and a lower head part preferably connected with the former in one piece, particularly configured or produced in one piece;
e) a slit is provided between the upper head part and the lower head part, which slit is open toward the related vertical support;
f) the connecting head, in each instance, of the transverse rung is set, with its slit, onto the perforated disk of the vertical post, in each instance, which disk projects into the slit, at least in part, and is attached to the vertical support, in each instance, preferably also to the perforated disk, in each instance, by means of welding.

In this way, expanded application and use possibilities and/or cost savings effects can be created, particularly on the basis of scaffold components that can be connected matching to a modular scaffold, above all the Layher Allround modular scaffold, in accordance with its raster dimensions. Also, because of the above measures, advantageous possibilities exist for simple, flexible, and variable adaptation of the distances between the vertical supports, particularly of horizontally adjacent vertical frames, or of support constructions, adapted to the load conditions that prevail on site or the support forces required on site or the scope for safe support of loads to be carried. Such vertical frames can be constructed using horizontal and/or diagonal holding devices, provided with perforated disk connecting heads, which are known from modular scaffolds, particularly with scaffold bars and/or scaffold diagonals, to form a particularly rigid and stable scaffold, particularly a load-bearing scaffold, or height block of a scaffold, particularly a load-bearing scaffold, from which particularly rigid and stable scaffolds, particularly load-bearing scaffolds or load-bearing scaffold towers can be constructed. Furthermore, such vertical frames or the vertical frame supports or vertical frame arrangements or scaffolds, particularly load-bearing scaffolds or load-bearing scaffold towers, constructed from them can be connected, in conventional manner, using such holding devices intended for connection to perforated disks, such as scaffold elements that run horizontally and/or diagonally, particularly scaffolds bars and/or scaffold diagonals, of a modular scaffold, so that a conventional modular scaffold can be constructed directly in connection with and firmly connected with the vertical frame or a vertical frame support or vertical frame arrangement constructed from it, or a scaffold constructed from it, particularly a load-bearing scaffold or a load-bearing scaffold tower, in torsion-resistant manner.

Furthermore, the vertical frames according to the invention can now be constructed, accordingly, to form scaffolds, particularly load-bearing scaffolds or load-bearing scaffold towers, or height blocks of scaffolds, particularly load-bearing scaffolds or load-bearing scaffold towers, that have different layouts, using horizontally adjacent, vertical frames according to the invention, particularly the same or identical frames, by means of holding devices intended for connection to the perforated disks, particularly diagonal and/or horizontal scaffold elements, such as scaffold bars and/or scaffold diagonals of a modular scaffold, so that an adaptation of the load-bearing capacity of such a scaffold, particularly a load-bearing scaffold or load-bearing scaffold tower, can be achieved in simple manner, by means of compressing or extending its layout in one direction. Accordingly, the distances between the vertical supports of the horizontally adjacent vertical frames can therefore be adapted to the load to be carried, in each instance. This means an advantageous possibility for cost optimization.

Because the first horizontal arm and/or the second horizontal arm of the vertical frame has a connecting head configured for connecting to the perforated disks, on both ends, in each instance, which head has an upper head part and a lower head part, in each instance, and a slit configured between them, with which the connecting head, in each instance, is set onto the perforated disk, in each instance, which projects at least partly into the slit, and is welded to the vertical support, in each instance, in this set-on position, preferably also to the perforated disk, in each instance, vertical frames can be implemented with particularly great stability, particularly torsion resistance, and accordingly, scaffolds constructed from them, particularly load-bearing scaffolds or load-bearing scaffold towers, can also be implemented. In this way and by means of the connection possibility described above, of further reinforcing holding devices, particularly of scaffold elements of a modular scaffold that run horizontally and/or diagonally, it is possible to construct particularly stable scaffolds, particularly load-bearing scaffolds or load-bearing scaffold towers.

Because the connecting heads are delimited with side wall parts that have vertical surfaces that run toward a center, particularly toward a post and disk center of the related perforated disk, in wedge-like manner, which surfaces enclose a wedge angle that amounts, in particular, to 40 degrees to 50 degrees, preferably about 45 degrees, particularly about 44 degrees, a plurality of at least up to seven connecting heads of holding devices or support elements and/or connecting elements, particularly scaffold elements that run horizontally and/or diagonally, particularly of a modular scaffold can be connected there, in known manner, if necessary with reciprocal support.

Using such vertical frames according to the invention, provided with perforated disks, it is possible to construct not only scaffolds, particularly load-bearing scaffolds or load-bearing scaffold towers, which have the quadragonal, particularly rectangular or square layout that has been usual until now, but also, polygonal layouts, in other words, for example, triangular, pentagonal, hexagonal or octagonal, particularly closed layouts can also be implemented. In this manner, even greater flexibility or variability in the construction of scaffolds, particularly load-bearing scaffolds or load-bearing scaffold towers, which can be constructed or are constructed using such vertical frames, can be achieved.

A method for installing a or the scaffold according to the invention, particularly according to at least one of claims 1 to 13, can particularly be characterized by the following steps:
a) after completion of a vertical region, a vertical frame of the next vertical region is first set onto the vertical frame of this vertical region, preferably in such a manner that subsequently, a vertical frame arrangement in the form of a ladder for ascent or descent of a person is formed;
b) subsequently, the hip and/or back railing element or the hip and/or back railing elements for the next vertical region is/are guided upward from the ground or from the vertical region that has already been completed, particularly by a person standing on a floor plate of the vertical region that has already been completed, preferably by means of grasping it/them directly, and affixed to or fixed in place on the attachment position of the vertical frame that already belongs to the said next vertical region and has already been set onto the related vertical frame of the vertical region that lies underneath, and to/on the attachment position of the further vertical support;
c) preferably subsequently or before step b), at least one floor plate for the said next vertical region is guided upward, from the vertical region that has already been completed, particularly by a person standing on a floor plate of the vertical region that has already been completed, preferably by means of grasping it directly, and affixed to or fixed in place on an attachment position for the floor plate, which position belongs to the vertical region that has already been completed, preferably to/on the hip and/or back railing element of the vertical region that has already been completed and/or to/on the vertical frame of the vertical region that has already been completed, particularly on a transverse rung of its transverse rungs.

In this manner, a particularly secure structure can be implemented by means of or with a leading or fore-running hip and/or back railing, in connection with a corresponding side protection.

According to a particularly advantageous embodiment of the method, it can be provided
a) that after completion of a vertical region, a vertical frame of the next vertical region is first set onto, preferably set on the vertical frames of this vertical region, in each instance, preferably so that subsequently, at least two vertical frame arrangements in the form of a ladder, in each instance, for ascent or descent of a person, are formed;
b) that subsequently, the hip and/or back railing element or the hip and/or back railing elements for the next vertical region is/are guided upward from the ground or from the vertical region that has already been completed, particularly by a person standing on a floor plate of the vertical region that has already been completed, preferably by means of grasping it/them directly, and is/are affixed to or fixed in place on the attachment positions of the vertical frame that already belongs to the said next vertical region and has already been set onto the related vertical frame, in each instance, of the vertical region that lies underneath;
c) preferably, that subsequently or before step b), at least one floor plate for the said next vertical region is guided upward, from the ground or from the vertical region that has already been completed, particularly by a person standing on a floor plate of the vertical region that has already been completed, preferably by means of grasping it directly, and affixed to or fixed in place on an attachment position for the floor plate that belongs to the vertical region that has already been completed, preferably on the hip and/or back railing element(s) of the vertical region that has already been completed, and/or on the vertical frame of the vertical region that has already been completed, particularly on a transverse rung, in each instance, of its transverse rungs.

In this way, an even more secure structure can be implemented by means of or with a leading or fore-running, particularly circumferential hip and/or back railing.

Subsequently, the person can climb up from the vertical region that has already been completed, in an interior of the scaffold delimited by the hip and/or back railing element(s) and either by the vertical frame and the further vertical support of this vertical region, or by the horizontally adjacent vertical frame of this vertical region, specifically by way of the transverse rungs of the ladder or one of the ladders, to the floor plate of the said next vertical region, which is already secured to prevent people from falling down to the side, with the hip and/or railing element(s) that has/have previously been affixed there.

For constructing the said next vertical region, it can preferably be provided that at least one floor plate, preferably multiple floor plates of the vertical region that has already been completed is/are used. In this way, the construction or assembly of the scaffold can be carried out in particularly material-saving and cost-saving manner.

In particularly preferred manner, it can be provided that for the construction of the said next vertical region, a person standing on a floor plate of the vertical region that has already been completed removes another floor plate of this vertical region, and subsequently moves this other floor plate upward, preferably while still standing on the floor plate of this vertical region, and affixes it to or fixes it in place on an attachment position for the floor plate that belongs to the vertical region that has already been completed, preferably on the hip and/or back railing element(s) of the vertical region that has already been completed, particularly on a or a respective transverse rung of its transverse rungs. This allows a particularly economical and, at the same time, safe way of working.

According to a particularly preferred embodiment of the method, it can be provided that for the construction of the said next vertical region, all the other floor plates of the vertical region that has already been completed are used, except for a single floor plate of the vertical region that has already been completed, which remains in place there. In this way, the use of material and costs can be reduced to a minimum, while maintaining maximal safety during installation of the scaffold, in other words without thereby impairing safety.

In the case of the method for removing a scaffold, particularly according to at least one of claims 1 to 13, it can be provided that the steps described above, or the steps according to claim 14 or 15 or 16 are performed in the reverse order.

It is understood that the above characteristics and measures can be combined in any desired manner, within the scope of feasibility.

Further characteristics, advantages, and aspects of the invention can be derived from the following description part, in which advantageous embodiments of the invention are described using the figures.

These show:

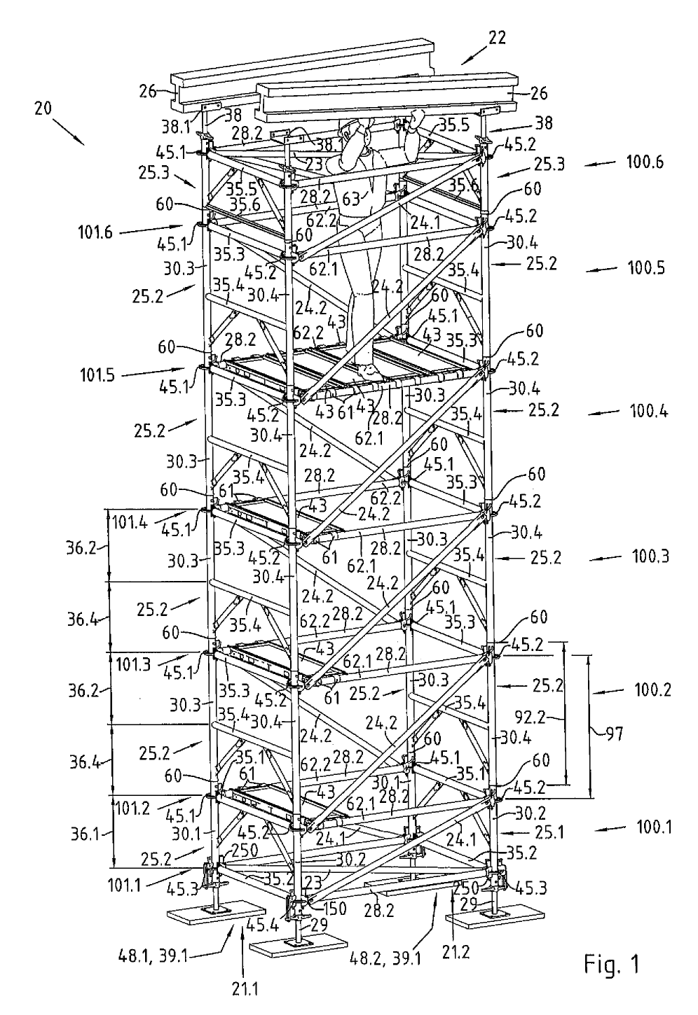

FIG. 1 a perspective view of a scaffold according to the invention, in the form of a load-bearing scaffold tower;

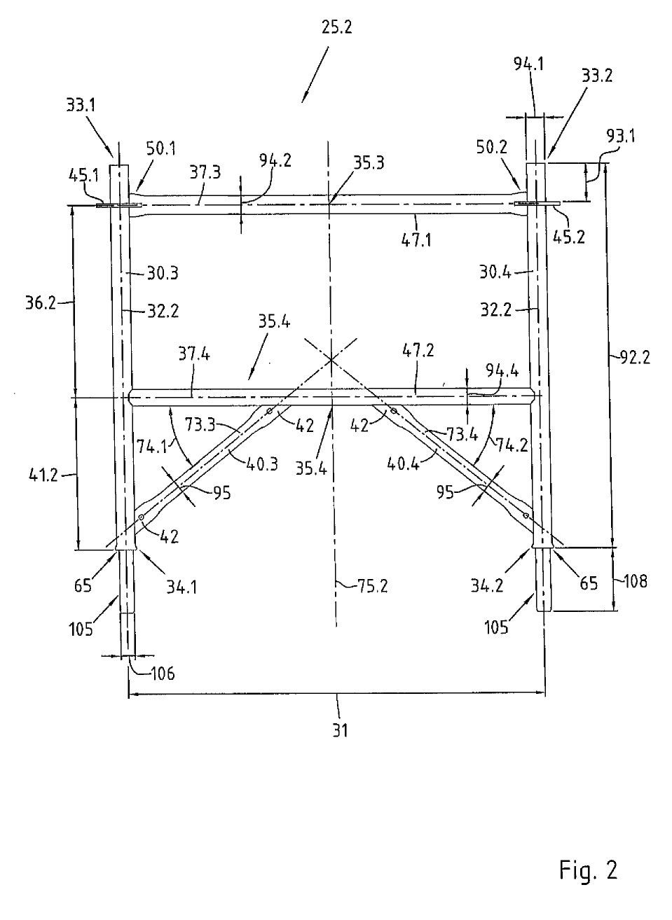

FIG. 2 a top view of a vertical frame according to the invention, also called a normal frame or standard frame or regular frame;

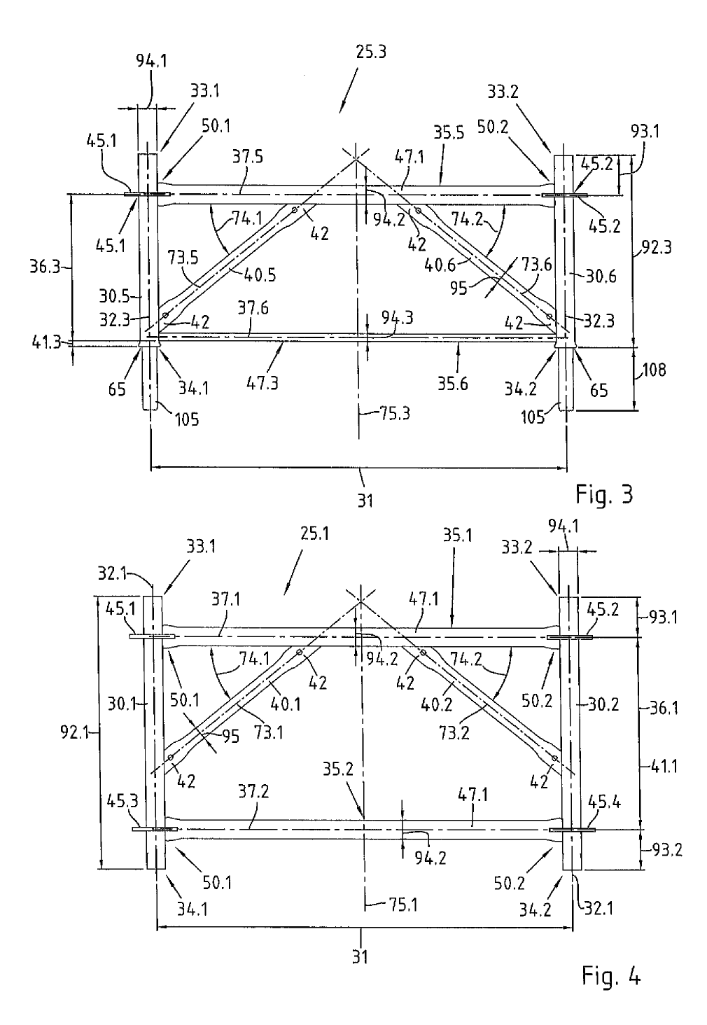

FIG. 3 a top view of a further vertical frame according to the invention, also called an equalization frame;

FIG. 4 a top view of a further vertical frame according to the invention, also called a starting frame;

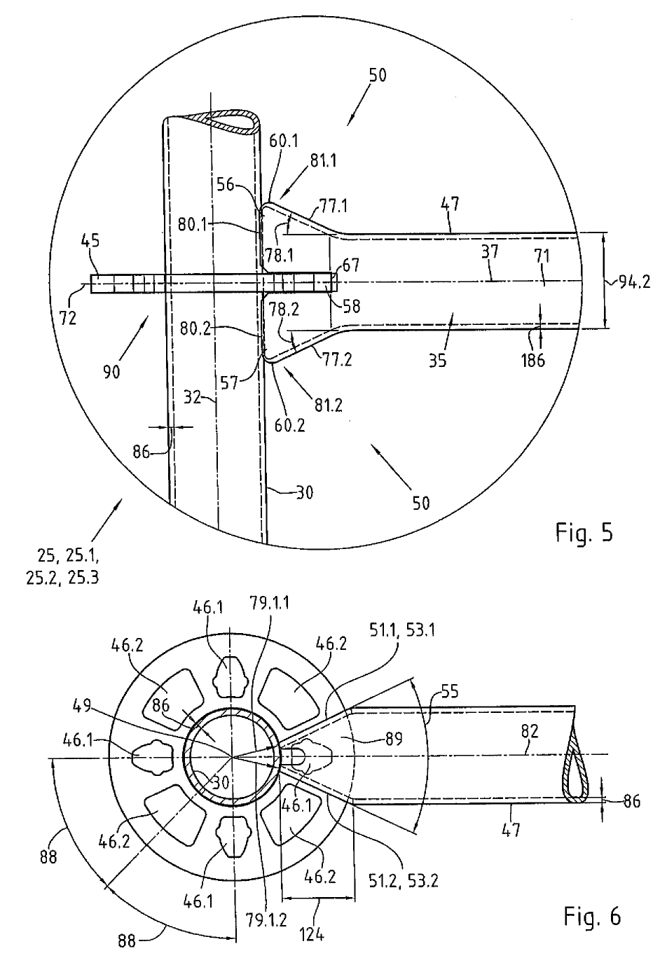

FIG. 5 an enlarged partial view of a connecting node of those connecting nodes that are shown at the top left in FIGS. 2 to 4, in each instance;

FIG. 6 a partial top view of the connecting node shown in

FIG. 5, with a vertical support in a sectional representation;

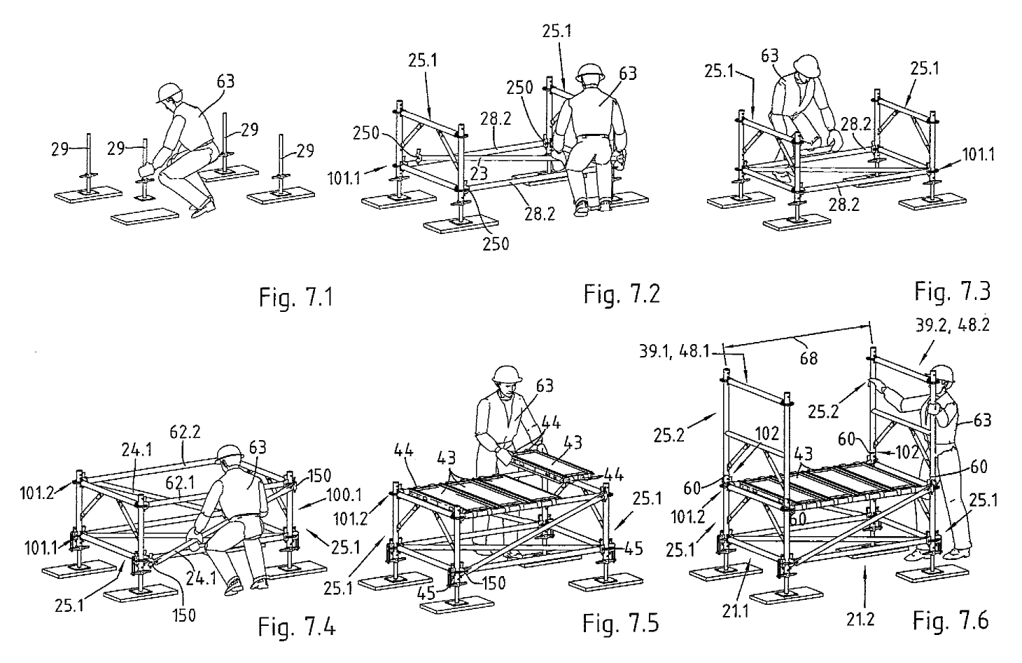

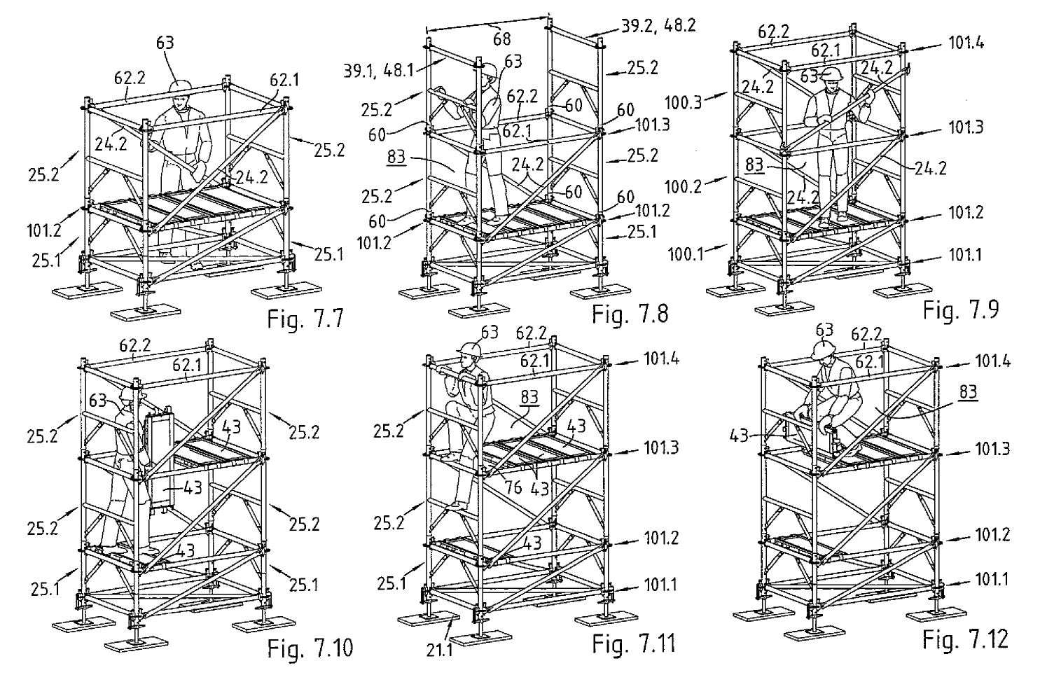

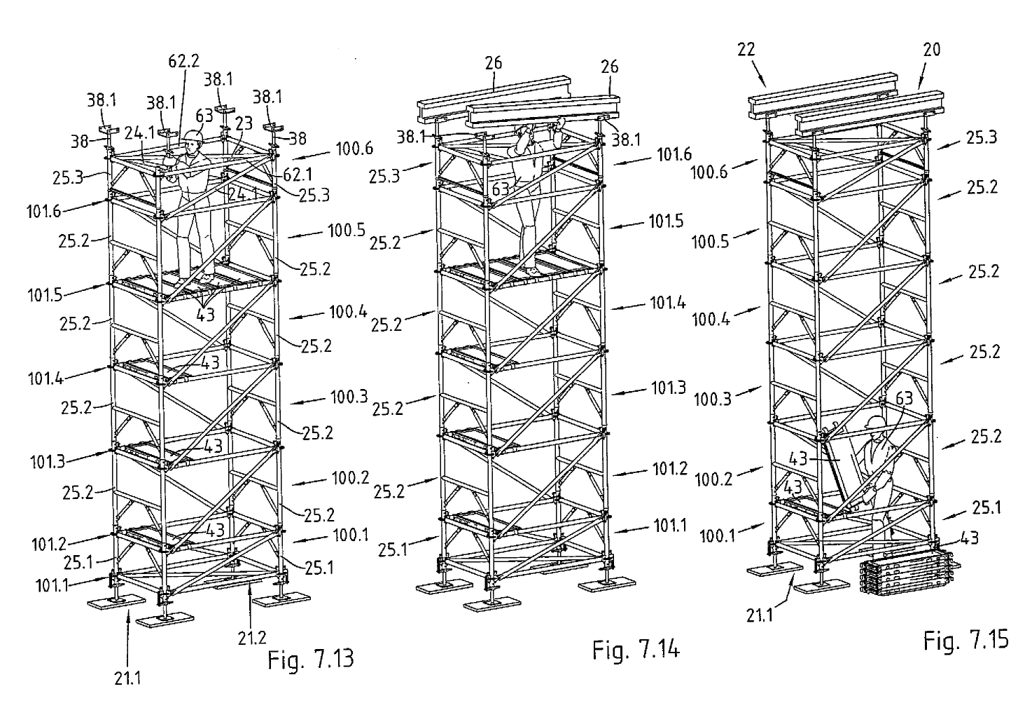

FIGS. 7.1 to 7.15
a procedure sequence of installation steps in the installation of the scaffold or load-bearing scaffold tower according to the invention, in a perspective representation, in each instance.

FIG. 1 shows an exemplary embodiment of a scaffold 20 according to the invention, which is constructed as a falsework or load-bearing scaffold tower 22. This load-bearing scaffold tower 22 has a rectangular layout. The load-bearing scaffold tower 22 is constructed from vertical frame supports 48.1, 48.2 according to the invention, in the form of vertical frame arrangements 39.1, 39.2. These are constructed as a ladder 21.1, 21.2, in each instance, having transverse rungs 35, also called horizontal arms, disposed uniformly over its length, at equal distances 36.1, 36.2, 36.4 from one another. These constructions are based on the use of multiple vertical frames 25; 25.1, 25.2, 25.3 according to the invention, set onto or set on one another. The vertical frames 25.1, 25.2, 25.3 are disposed in pairs, in each instance, at a horizontal distance from one another and in pairs, in each instance, at essentially the same height. This horizontal distance is determined here by the length of longitudinal bars or scaffold bars 28.2, which are also called connecting elements. Each of these scaffold bars 28.2 has connecting heads 250 of a modular scaffold system, which are actually known, here of the Layher Allround scaffold system, at its two ends. The scaffold bars 28.2 have a length or connection length, in each instance, which amounts to 1.57 cm here. It is understood, however, that the length of the scaffold bars that connect the vertical frames 25.1, 25.2, 25.3 can also be selected to be longer or shorter, for example can amount to 1.09 m or 2.07 m or 2.57 m or 3.07 m, so that a scaffold or load-bearing scaffold having a quadragonal layout or having a longer, stretched-out layout can be constructed as a function of their length.

Multiple height blocks 100.1, 100.2, 100.3, 100.4, 100.5, 100.6 are formed with two of these vertical frames 25.1, 25.2, 25.3, in each instance, which frames are disposed in pairs and are the same or identical.

The first height block 100.1, assigned to the ground, serves as a starting height block 100.1 and is structured accordingly. The starting height block 100.1 is constructed with two vertical frames 25.1, 25.1 that are horizontally spaced apart, serving as starting frames 25.1, 25.1, in each instance, with two vertical diagonals 24.1, 24.1 that connect them laterally, as well as with horizontal scaffold bars or longitudinal bars 28.2, which are disposed in the region of the vertical plane spanned by the vertical diagonal 24.1, in each instance, and which also connect the two vertical frames 25.1, 25.1.

The vertical diagonal 24.1, 24.1, in each instance, and the scaffold bar 28.2, 28.2, in each instance, are known scaffold components of a modular scaffold, here of the Layher Allround scaffold system. Accordingly, each vertical diagonal 24.1, 24.1 has a known connecting head 150 at its two ends, which head is attached to the diagonal strut in articulated manner, and which head has a slit configured between an upper head part and a lower head part, by way of which slit the connecting head 150, in each instance, is set onto one of the two perforated disks 45 provided on the vertical support 30.1, 30.2, in each instance, of the starting frame 25.1, 25.1, in each instance. The connection of the vertical diagonals 24.1, 24.1 to the two starting frames 25.1, 25.1 takes place in known manner, using a releasable wedge, in each instance, which is inserted through an upper wedge opening and a lower wedge opening of the connecting head 150, in each instance, of the vertical diagonals 24.1, 24.1, in order to brace the components to be connected against one another, and is or has been fixed in place by hitting it, preferably with a hammer.

The scaffold bars 28.2, 28.2 also have a known connecting head 250 at their two ends, in each instance. This head is welded onto the rod or scaffold pipe, in each instance, in known manner. This connecting head 250 also has an upper head part and a lower head part, between which a slit is provided, by way of which the connecting head 250, in each instance, is set onto one of the two perforated disks 45 provided on the vertical support 30.1, 30.2, in each instance, of the vertical frame 25; 25.1, 25.2, 25.3, in each instance. The connection of the scaffold bars 28.2, 28.2 to the two equalization frames 25.1, 25.1 once again takes place in known manner, using a releasable wedge, in each instance, which is inserted through an upper wedge opening and a lower wedge opening of the connecting head 250, in each instance, of the scaffold bars 28.1, 28.1, in order to connect the components to be connected, and is or has been fixed in place by hitting it, preferably with a hammer.

For the purpose of reinforcing the load-bearing scaffold 20 in a horizontal plane, a further horizontal scaffold bar in the form of a horizontal diagonal 23 is additionally provided in the equalization height block 100.1. This diagonal is attached between two of the lower perforated disks 45 of the two equalization frames 25.1, 25.1 that lie diagonally opposite one another, using connecting heads 250. Except for its length, the horizontal diagonal 23 has the same structure as the scaffold bar 28.2, in each instance.

A known foot spindle 29 is inserted into the lower ends 34.1, 34.2 of the vertical supports 30.1, 30.2 of the two equalization frames 25.1, 25.1, in each instance (see also FIGS. 7.1 and 7.2), by means of which spindle a precise adjustment and consequently an alignment of the said first lower height block 100.1 and consequently of the entire scaffold 20 can be achieved, in each instance.

Five further height blocks 100.2 to 100.6 are constructed above the first height block 100.1 formed with the two starting frames 25.1, 25.1. The height block 100.6 provided in the region of the upper end of the load-bearing scaffold 21.1 or of the load-bearing scaffold tower 22.1 is structured as an equalization height block 100.6. The height blocks 100.2 to 100.5 disposed between it and the starting height block 100.1 form normal or standard or regular height blocks, in each instance.

The upper equalization height block 100.6 is constructed with two equalization frames 25.3, 25.3 and otherwise with essentially the same components as the lower starting height block 100.1, so that in this regard, reference can be made to the above explanations. As a further difference from this, in the case of the upper equalization height block 100.4, the horizontal diagonal 23.1 provided for horizontal reinforcement is fixed in place on two of the upper perforated disks 45 of the vertical supports 30.5, 30.6 of the equalization frame 25.3 that lie diagonally opposite one another, by way of its connecting heads 250.

It is understood that such a scaffold or load-bearing scaffold or that such a load-bearing scaffold tower can also be constructed without an equalization height block 100.6 or without a starting height block 100.1, or also leaving out not only the starting height block 100.1 but also the equalization height block 100.6. In other words, a scaffold according to the invention can also be constructed only of height blocks that can be formed exclusively with standard or normal or regular frames, in the form of the vertical frames 25.2 or vertical frames having a similar structure.

The further height blocks 100.2 to 100.5 provided in FIG. 1 between the starting height block 100.1 and the equalization height block 100.6 are therefore constructed, in each instance, with vertical frames 25.2, 25.2 according to the invention that are also called standard or normal or regular frames 25.2, 25.2. These vertical frames 25.2 differ from the starting frames 25.1 particularly in that they have only one perforated disk 45; 45.1, 45.2, in each instance, in the region of the upper ends 33.1, 33.2, in each instance, of their vertical supports 30.3, 30.4, and furthermore in that the standard frames 25.2, 25.2 have a greater height 92.2. With regard to the design details of the starting frames 25.1 according to the invention, the standard frames 25.2 according to the invention, and the equalization frames 25.3 according to the invention, reference can be made, in particular, to the explanations below, particularly regarding FIGS. 2 to 4.

In similar manner as in the case of the starting frames 25.1, 25.1 and also in similar manner as in the case of the equalization frames 25.3, 25.3, the two standard frames 25.2, 25.2 are also connected with one another using two vertical diagonals 24.2, 24.2. The vertical diagonals 24.2, 24.2 have a greater length, in comparison with the vertical diagonals 24.1, 24.1, but for the remainder are structured the same as the vertical diagonals 24.1 are.

Connecting the two standard frames 25.2, 25.2 of the height block 100.2 to 100.5, in each instance, using the two vertical diagonals 24.2, 24.2, takes place in such a manner that each of the vertical diagonals 24.2 is fixed in place, with a first, upper connecting head 150, on the perforated disk 45.1, 45.2 attached in the region of the upper end 33.1, 33.2 of the vertical supports 30.3, 30.4 of the standard frame 25.2, 25.2, in each instance, of the same height block, while the other, lower connecting head 150, in each instance, of the vertical diagonals 24.2, 24.2 is attached to a perforated disk 45 attached in the region of the upper end 33 of a vertical support 30 of a vertical frame 25.1 or 25.2, respectively, disposed horizontally apart and below, of a height block that lies underneath.

The distance 97 of the perforated disks 45 attached to the vertical supports 30.3, 30.4 of a set-on standard frame 25.2, 25.2 from the perforated disks attached to the vertical frame 25.2, 25.1 that lies underneath, onto which the set-on standard frame 25.2, 25.2 is set, here amounts to about 100 cm. In other words, the said two perforated disks 45, 45 have a vertical distance 97 of about 1.0 m, by way of the frame level 60. An advantage of this raster dimension of 1.0 m is that so-called serial diagonals of a modular scaffold system, here of the Layher Allround scaffold system, can be used, in cost-advantageous manner.

As is evident from FIG. 1, a further horizontal longitudinal or scaffold bar 28.2 is fixed in place, in each instance, between the two vertical frames or standard frames 25.2, 25.2, in each instance, of the height block 100.2 to 100.5, in each instance, specifically on the perforated disks 45, which are horizontally spaced apart, of the vertical frames 25.2, 25.2 that lie opposite one another at a horizontal distance, at essentially the same height. These scaffold bars 28.2, 28.2 are also disposed parallel to one another and, in each instance, perpendicular to the vertical planes spanned by the two vertical frames 25.1, 25.1 or 25.2, 25.2 or 25.3, 25.3, in each instance, which are disposed at essentially the same height. These scaffold bars 28.2, 28.2, also called connecting elements, serve, at least during installation of the scaffold 20, as hip and/or back railing elements 62.1, 62.2 of a railing installed as a leading railing, as will be described in greater detail below, in connection with FIGS. 7.1 to 7.13. The said horizontal scaffold bars 28.2, 28.2 furthermore serve, at least during installation of the scaffold 20, as floor plate support elements 62.2, 62.2 for floor plates 43 that can be disposed or are disposed in vertical regions 101.2 to 101.5, which are disposed one on top of the other, in tier-type manner. According to an advantageous exemplary embodiment of the method according to the invention for installing the scaffold 20 according to the invention, after a scaffold 20 has been constructed to the desired height, for example as shown in FIG. 1 as well as 7.13 and 7.14, in the uppermost tier, in other words here in the vertical region 101.5, the scaffold bars 28.2, 28.2 that are attached to the perforated disks 45 of the two vertical frames 25.2, 25.2 assigned to this vertical region 101.5 are covered essentially completely with floor plates 43, so that this uppermost work platform is equipped with an essentially closed or continuous floor covering. In contrast to this, in the vertical regions 101.5, 101.4, 101.3, and 101.2 that lie underneath, in each instance, in tier-type manner, only one floor plate 43, in each instance, is laid onto the two horizontal scaffold bars 28.2, 28.2, in each instance, which plates have remained there according to an advantageous exemplary embodiment of the method according to the invention for installing the scaffold 20 according to the invention. It is understood, however, that alternatively, for example, a work platform with multiple floor plates 43 can be or is constructed, in each instance, in every second one of the vertical regions that lie one on top of the other, so that a work scaffold, for example a façade scaffold or also a mobile scaffold, having multiple work tiers, is then available.

The floor plates 43, also called scaffold floors, have suspension hooks 44 that are U-shaped in cross-section here, by means of which the floor plates 43 can be or are laid onto the longitudinal bars or scaffold bars 28.2, 28.2 that are configured as round pipes here, in each instance. In this or a similar manner, a scaffold 22 according to the invention or a load-bearing scaffold tower 22 according to the invention can additionally be used also as a work scaffold or the like.

In order to support loads to be absorbed by the vertical frames 25 according to the invention or by the frame support 20 or by the load-bearing scaffold 21 according to the invention or by the load-bearing scaffold tower 22 according to the invention, a known head spindle 38 can be provided, in each instance, on the upper end, in each instance, of the vertical supports 30 of the equalization frames 25.1, 25.2 disposed in the uppermost height block 100.6, which spindle in turn can be inserted into the scaffold pipes of the vertical supports 30 of the equalization frames 25.1, 25.1 that are configured as round pipes made of steel. These head spindles 38 can be provided, again in known manner, with contact parts 38.1 that are U-shaped in cross-section, to be laid on or to accommodate load carriers or formwork carriers, here in the form of I-beams 26. It is understood that the head spindles can also be structured to be adapted for supporting and/or accommodating other support bodies, for example in the form of crosshead spindles, in which a contact plate and multiple support profiles that are horizontally spaced apart and proceed from this plate can be provided in the region of their upper ends.

Preferred exemplary embodiments of vertical frames 25; 25.1, 25.2, 25.3 according to the invention are particularly shown in FIGS. 2 to 4. Each of these vertical frames 25; 25.1, 25.2, 25.3 is constructed from two parallel vertical supports 30.1, 30.2; 30.3, 30.4; 30.5, 30.6 that are disposed at a horizontal distance 31 from one another, and two parallel horizontal arms 35; 35.1, 35.2; 35.3, 35.4; 35.5, 35.6 that are disposed at a vertical distance 36.1, 36.2; 36.3 from one another, which are welded to one another, forming a closed frame 25. In this connection, the two horizontal arms 35.1, 35.2; 35.3, 35.4; 35.5, 35.6, in each instance, i.e. their longitudinal axes 47.1; 47.2; 47.3 are disposed perpendicular to the vertical supports 30.1, 30.2; 30.3, 30.4; 30.5, 30.6, i.e. to their longitudinal axes 32.1; 32.2; 32.3 and welded in place there. Each horizontal arm 35.1 to 35.6 is therefore welded to two of the horizontally spaced-apart, parallel vertical supports 30.1, 30.2; 30.3, 30.4; 30.5, 30.6, specifically, in the exemplary embodiment shown, in such a manner that the horizontal arm 35.1, 35.2; 35.3, 35.4; 35.5, 35.6, in each instance, extends between the two vertical supports 30.1, 30.2; 30.3, 30.4; 30.5, 30.6, in each instance.

Each vertical frame 25; 25.1, 25.2, 25.3 furthermore also has two diagonal rods 40; 40.1, 40.2; 40.3, 40.4; 40.5, 40.6 configured as corner reinforcements, in each instance, which diagonally reinforce the frame, in each instance. In the exemplary embodiments shown, the diagonal rods 40; 40.1, 40.2; 40.3, 40.4; 40.5, 40.6, in each instance, are configured to be the same or identical, thereby making it possible to achieve cost savings effects. Each diagonal rod 40.1, 40.2; 40.3, 40.4; 40.5, 40.6 is disposed at a preferably equal-size angle 74.1, 74.2 relative to the horizontal arm 35.1; 35.4; 35.5, in each instance, at which the diagonal rod 40.1, 40.2; 40.3, 40.4; 40.5, 40.6, in each instance, is also welded on, as to the related vertical support 30.1, 30.2; 30.3, 30.4; 30.5, 30.6 of the vertical frame 25.1; 25.2; 25.3, in each instance. The diagonal rods 40.1, 40.2; 40.3, 40.4; 40.5, 40.6 therefore extend, in each instance, between a horizontal arm 35.1; 35.4; 35.5 and a vertical support 30.1, 30.2; 30.3, 30.4; 30.5, 30.6 of the vertical frame 25.1; 25.2; 25.3, in each instance, and are welded on with their ends there. The ends of the diagonal rod 40.1, 40.2; 40.3, 40.4; 40.5, 40.6, in each instance, are configured as flat connectors 42, in each instance. For this purpose, the diagonal rods 40.1, 40.2; 40.3, 40.4; 40.5, 40.6, which are configured as round pipes here, are compressed or pressed together at their ends, in each instance. The upper ends of the two diagonal rods 40.1, 40.2; 40.3, 40.4; 40.5, 40.6, in each instance, of the vertical frame 25.1, 25.2, 25.3, in each instance, are welded to the horizontal arm 35.1, 35.4, 35.5, in each instance, at a horizontal distance from one another. In the case of the vertical frames 25.1 and 25.3, in other words the starting frame 25.1 and the equalization frame 25.3, the diagonal rods 40.1, 40.2 or 40.5, 40.6, respectively, in each instance, are welded to the upper horizontal arm 35.1 or 35.5, respectively, in each instance, of the two horizontal arms 35.1, 35.2 or 35.4, 35.6, respectively, in each instance, and extend from there, proceeding in the direction of the lower horizontal arm 35.2 or 35.6, respectively, in each instance. These diagonal rods 40.1, 40.2; 40.5, 40.6 furthermore extend, in each instance, in a plane spanned by the two horizontal arms 35.1-35.2 or 35.5-35.6, respectively, in each instance. In contrast to this, the diagonal rods 40.3 and 40.4 of the vertical frame 25.2, in other words of the standard or normal or regular frame 25.2, are welded onto the lower horizontal arm 35.4 of the two horizontal arms 35.3, 35.4, in each instance, and extend from there, proceeding in a direction away from the upper horizontal arm 35.3 or in the direction of the lower ends 34.1, 34.2 of the vertical supports 30.3, 30.4. These diagonal rods 40.3, 40.4 also extend, in each instance, in a vertical plane spanned by the two horizontal arms 35.3, 35.4 or by the vertical supports 30. It is understood, however, that such or other diagonal rods do not necessarily have to be disposed in the plane spanned by the vertical supports 30 and/or in the one spanned by the horizontal arms 35.

The vertical frames 25.1, 25.2, 25.3 according to the invention are configured to be symmetrical to their vertical center axis 75.1, 75.2, 75.3, in each instance. In this way, not only are static advantages brought about, but also installation advantages, because it is not necessary to pay attention to installation on the correct side.

In the exemplary embodiments shown, the diagonal rods 40; 40.1, 40.2, 40.3, the vertical supports 30; 30.1, 30.2; 30.3, 30.4; 30.5, 30.6, and the horizontal struts 47; 47.1, 47.2 of the horizontal arms 35.1 to 35.5, as well as the scaffold bars 28.2 and the diagonals 23, 24.1, 24.2, in each instance, are configured with straight round pipes made of steel, preferably zinc-plated steel. Preferably, scaffold pipes that are available as standard products are used for this purpose. In contrast to this, the horizontal strut 47.3 of the lower horizontal arm 35.6 of the vertical frame or equalization frame 25.3 is configured as a quadragonal profile or four-corner profile. This also consists of steel, preferably zinc-plated steel. It is understood, however, that these scaffold components, in particular, can also consist of other metals, particularly of light metal, for example of aluminum.

The vertical supports 30.1, 30.2; 30.3, 30.4; 30.5, 30.6, preferably also the horizontal struts 47.1 of the horizontal arms 35.1, 35.2; 35.3; 35.5 of the vertical frames 25.1, 25.2, 25.3 have an outside diameter 94.1 or 94.2 that amounts to 48.3 mm here, preferably whereby the wall thickness amounts to only 3.2 mm. This is a standardized dimension, particularly in the case of modular scaffolds such as the Layher Allround scaffold system. Providing the scaffold pipes having an outside diameter of 48.3 mm has the advantage, among other things, that standard scaffold couplings can be connected to the vertical frames 25, if necessary.

Preferably, in contrast to this, the horizontal strut 47.2 of the lower horizontal arm 35.4 of the vertical or standard frame 25.2 can have a slightly smaller outside diameter 94.4, which can amount to 42.4 mm, for example. It is understood, however, that the outside diameter of the horizontal strut of the lower horizontal arm of the standard frame can be of the same size or even slightly greater than the outside diameter of the upper horizontal struts of the vertical frames. The horizontal strut 47.2 of the lower horizontal arm 35.4 of the vertical or standard frame 25.2 preferably has a wall thickness of only 2.5 mm. It is understood, however, that the wall thickness can also be of equal size or even slightly greater than the wall thickness of the upper horizontal struts of the vertical frames.

The diagonal struts 40; 40.1, 40.2, 40.3 of the vertical frames 25; 25.1, 25.2, 25.3 have an outside diameter 95 that amounts to only 33.7 mm here. The wall thickness of the diagonal struts is preferably less than the wall thickness of the horizontal struts. It can preferably amount to only 2.25 mm.

The lower horizontal arms 35.6 or the horizontal struts 47.3 of the vertical or equalization frames 25.3 can preferably be configured as four-corner pipes, preferably rectangular pipes, whereby the latter preferably can have a height or thickness of about 20 mm, a width of about 40 mm, and a wall thickness of about 2.0 mm.

The vertical frames 25; 25.1, 25.2, 25.3 according to the invention are particularly characterized in that, at least in the region of the upper end 33.1, 33.2, in each instance, of their vertical supports 30; 30.1, 30.2; 30.3, 30.4; 30.5, 30.6, at least at least one, in each instance, perforated disk 45; 45.1, 45.2, provided with multiple perforations 46; 46.1, 46.2, is permanently attached, here by means of welding, for connecting holding devices, particularly for suspension of support and/or connecting elements, preferably of scaffold elements that run horizontally and/or diagonally, for example scaffold bars and/or scaffold diagonals, such as those shown in FIGS. 1 and 7, for example, in the form of horizontal scaffold bars 28.2 and/or diagonals 23, 24.1, 24.2, particularly of a modular scaffold, here of the Layher Allround scaffold system.

While the vertical frames 25.2 and 25.3 according to the invention, in other words the standard or normal or regular frames 25.2 and the equalization frames 25.3 have only two perforated disks 45.1, 45.2, in each instance, specifically in the region of an upper end 33.1, 33.2 of their vertical supports 30.1, 30.2 or 30.3, 30.4, respectively, in each instance, the vertical frames 25.3, in other words the starting frames 25.3, additionally comprise two further perforated disks 45.3, 45.4, of which one is attached, in each instance, in the region of the lower end 34.1 or 34.2, in each instance, of the vertical support 30.1 or 30.2, in each instance. These additional perforated disks 45.3 and 45.4 are configured to be the same as or identical to the perforated disks 45.1 and 45.2.

Each perforated disk 45 of these perforated disks 45 is disposed concentric to the vertical support 30, in each instance, and surrounds the vertical support 30, preferably over its full circumference, in the manner of a flange. It is understood, however, that instead of the perforated disks 45 as shown, other attachment means can also be provided, to which the scaffold components that can be attached or are attached there, particularly the connecting and/or holding and/or support elements, can be configured to be adapted.

The horizontal arms 35.1 to 35.5 comprise at least one, particularly a straight horizontal strut 47.1 or 47.2, in each instance, which is configured or provided with a connecting head 50, in each instance, at its ends that face away from one another, preferably in one part or in one piece, or in multiple parts. In the exemplary embodiments shown, the connecting heads 50, in each instance, of the horizontal arms 35.1 to 35.5 of the vertical frames 25.1, 25.2, 25.3 are configured or produced in one part or in one piece, in each instance, with the horizontal strut 47, in each instance.

The placement and the configuration of the connecting heads 50 formed in one part or in one piece, in each instance, and from the same material as the preferably straight rod, here with a horizontal strut 47, are particularly evident from FIGS. 5 and 6. The connecting head 50, there designated in general with the reference symbol 50, has an upper head part 56 and a lower head part 57, which are connected in one piece with one another or that are configured or produced in one part. The upper head part 56 has upper side wall parts 51.1 and 51.2, and the lower head part 57 has lower side wall part 52.1 and 52.2. The upper vertical outer surfaces 53.1 and 53.2 as well as the lower vertical surface 54.1 and 54.2 of the side wall parts 51.1, 51.2; 52.1, 52.2 run toward a center, particularly a post and disk center 49, in wedge-like manner, and enclose a wedge angle 55 that amounts to about 44 degrees here. A horizontal slit 58 is provided between the upper head part 56 and the lower head part 57 of each connecting head 50 of the horizontal arms 35 of the vertical frames 25, which slit is open toward the assigned vertical strut 30 and toward the vertical outer surfaces 53.1, 53.2; 54.1, 54.2. The slit 58 is delimited by horizontal upper and lower slit surfaces 66.1, 66.2, which are disposed parallel to one another and parallel to the longitudinal axis 37, in each instance, of the horizontal arm 35, in each instance, or to its horizontal strut 47, in each instance. The slit 58 has a slit width 70 that amounts to about 10 mm, whereby the slit width 70 is only slightly greater than the thickness of the perforated disk 45, in each instance, which amounts to about 9 mm here.

The connecting head 45, in each instance, is set onto the perforated disk 45, which projects into the slit 58 at least in part, and is welded to the vertical support 30, in each instance, here also to the perforated disk 45, in this set-on position. In this manner, stable vertical frames 25; 25.1, 25.2, 25.3, which are particularly resistant to bending and torsion, are created, which can be used in many different advantageous ways to construct spatial support structures, particularly scaffolds 20, frame supports, load-bearing scaffolds or load-bearing scaffold towers 22, which structures are compatible with a matching modular scaffold, in other words can be combined with it, which is also constructed with or can be constructed with posts having corresponding or matching perforated disks. In particular, two or more of the vertical frames 25; 25.1, 25.2, 25.3 according to the invention can be connected, preferably in pairs, by means of scaffold components that can also be used in a matching modular scaffold, in other words, in particular, scaffold bars, for example longitudinal and/or transverse bars and/or diagonals, as they can be used, in particular, in the form of vertical and/or horizontal diagonals of such a modular scaffold.

The connecting heads 45 are welded onto one of the vertical supports 30 of the vertical frame 25, in each instance, in such a manner that the horizontal plane 71 that intersects the slit 58 at the height of half the slit width 70 lies approximately in the center plane 72 that intersects the perforated disk 45 approximately at the height of its center. Each connecting head 50 is configured to be symmetrical to the horizontal plane 71 and also symmetrical to a vertical plane 82 that is disposed perpendicular to the former and also contains the longitudinal axis 47 of the horizontal arm 35 or of its horizontal strut 47. The upper head part 56 has upper vertical contact surfaces 80.1.1, 80.1.2, and the lower head part 57 has lower vertical contact surfaces 80.2.1, 80.2.2, with which the connecting head 50 lies against the outer surface of the vertical support 30. The upper end 81.1 of the upper head part 56 and the lower end 81.2 of the lower head part 57 project beyond the horizontal strut 47 of the horizontal arm 35, respectively its outside diameter, in the region of the contact surfaces 80.1, 80.2, in each instance, viewed in a direction perpendicular to the longitudinal axis 37 of the transverse arm 35 or of its horizontal strut 47. The height 76.1 of the upper head part 56 and the height 76.2 of the lower head part 57 decrease toward the back, here, continuously and without a bend, toward the outside diameter 94.2 of the horizontal strut 47 of the horizontal arm 35. The upper outer surface 77.1 and the lower outer surface 77.2 of the connecting head 50 are therefore inclined toward the horizontal strut 47 of the horizontal arm 35, in each instance, specifically, here, at an angle 78.1, 78.2 to an imaginary line that runs parallel to the longitudinal axis 37 of the transverse arm 35 or to its horizontal strut 47, which angle amounts to about 45 degrees here. The contact wall parts 80.1, 80.2 of the connecting head 50 have a partially cylindrical shape and are configured with a radius that corresponds to the outer radius of the vertical support 30, preferably amounting to about 24.15 mm here, viewed in a cross-section perpendicular to the longitudinal axis 32 of the related vertical support 30. The distances 76.1 of the upper end 81.1 of the upper contact surfaces 80.1, and the distances 76.2 of the lower end 81.2 of the lower contact surfaces 80.2 from the horizontal plane 71 that intersects the slit 58 at the height of half the slit width 70 have the same size. As is particularly evident from FIG. 6, the length 124 of the vertical outer surfaces 53.1, 53.2; 54.1, 54.2 of the side wall part 51.1, 51.2; 52.1, 52.2 of the connecting heads 50 amounts to about 35 mm, viewed in a projection direction perpendicular to the longitudinal axis 47 of the horizontal arm 35 or of its horizontal strut 47, and also perpendicular to the longitudinal axis 32 of the vertical supports 30. The connecting heads 50, which are produced in one part with the strut 47, or formed onto the strut 47 with the same material and in one piece, can be produced by means of forming, particularly by means of compressing or pressing together the ends, in each instance, of the horizontal strut 47, which is configured with a round pipe here.

The connecting head 50, in each instance, of the horizontal arms 35 is configured in such a manner and disposed on the related perforated disk 45, at least partly surrounding this disk with its slit 58, that with the exception of a single perforation 46.1, which is the smaller perforation 46.1 of the perforations 46; 46.1, 46.2 of the related perforated disk 45, all the other perforations 46.1 and 46.2 of this perforated disk 45 can be used for suspending usual connecting heads, particularly those of a modular scaffold, particularly of the Layher Allround scaffold system, which are provided, in each instance, with a non-detachable wedge, preferably scaffold elements that run horizontally and/or diagonally. Each connecting head 50 is welded not only to one of the vertical supports 30 of the vertical frame 25, but also to one of the perforated disks 45.

It is practical if the perforated disks 45 of the vertical frames 25 are configured in the same way as the perforated disks of a modular scaffold system, here of the Layher Allround scaffold system. Accordingly, the perforated disks 45 can be disposed concentric to the vertical support 30, in each instance, and can surround the vertical support 30, in each instance, in the manner of a flange, at least in part, preferably over the full circumference, specifically preferably without interruptions. The perforated disks 45 have at least three, here four small perforations 46.1 and four large perforations 46.2, which are disposed alternately, at the same circumference angles 88 of 45 degrees here. In this way, preferably releasable connecting heads 150, 250 of horizontal and/or diagonal connecting or scaffold elements, particularly of longitudinal and/or horizontal bars as well as diagonal rods, preferably of a modular scaffold, particularly of the Layher Allround scaffold system, can be suspended or fixed in place on these perforations 46.1, 46.2.

With regard to such mass-production connecting heads of a modular scaffold system plus mass-production perforated disks and mass-production connecting elements, known from the state of the art, reference can be made, for example, to DE patent 24 49 124, to DE 37 02 057 A or the parallel EP 0 276 487 B1, to DE 39 34 857 A1 or the parallel EP 0 423 516 B2, to DE 198 06 094 A1 or the parallel EP 0 936 327 B1, and to the parallel EP 1 452 667 B1 of the applicant.

Alternative perforated disk embodiments are evident, for example, from DE 39 09 809 A1 or the parallel EP 0 389 933 B1 and from DE 200 12 589 U1 as well as the parallel WO 02/06610 A1, and the parallel EP 1 301 673 A1 of the applicant. The content of these intellectual property rights is incorporated with their full content, at this point, for the sake of simplicity.

Aside from the characteristics also mentioned above, in part, the vertical frames 25; 25.1, 25.2, 25.3 according to the invention distinguish themselves by a number of other characteristics:

The vertical frame particularly shown in FIG. 4, also called a starting frame 25.1, has precisely two straight vertical supports 30.1 and 30.2, each having the same length 92.2. The length 92.1 corresponds, at the same time, to the effective length of the vertical frame 25.1 or its vertical supports 30.1, 30.2. The length 92.1 is less than the horizontal distance 31 between the two vertical supports 30.1, 30.2 or between the longitudinal axes 32.1, 32.1 of these two vertical supports 30.1 and 30.2. The length 92.1 of each of these vertical supports 30.1, 30.2 amounts to precisely 70.9 mm or about 0.71 m in the exemplary embodiment shown. The weight of this vertical or starting frame 25.1 amounts to only about 15 kg.

The horizontal distance 31 amounts to precisely 1088 mm, in each instance, in other words about 1.09 m, by the way also in the case of the two other vertical frames 25.2 according to FIGS. 2 and 25.3 according to FIG. 3. This corresponds to a system width of a matching modular scaffold system, here of the Layher Allround scaffold system.

Precisely two perforated disks 45.1 and 45.3 or 45.2 and 45.4 are attached to every vertical support 30.1 and 30.2 of the vertical or starting frame 25.1. Accordingly, in the vertical frame 25.1, four perforated disks 45 are provided, in total. The perforated disks 45.1 to 45.4 of every vertical support 30.1, 30.2 are fixed in place on the vertical supports 30.1, 30.2, at equal distances 93.1, 93.2 from their ends 33.1, 33.2; 34.1, 34.2, of about 100 mm here, in each instance, by means of welding.

The distance 41.1 between the two perforated disks 45.1, 45.3 and 45.2, 45.4, in each instance, of the vertical support 30.1 or 30.2, in each instance, corresponds to the vertical distance 36.1 of the horizontal arms 35.1 and 35.2 or their longitudinal axes 47.1, 47.1, which amounts to about 50 cm here, in other words about 0.5 m. In the constructed scaffold 20, the horizontal arms 35.1 and 35.2 form two transverse rungs 35 of a ladder 21. The horizontal arms 35.1 and 35.2 are therefore attached to the vertical supports 30.1 and 30.2 parallel to one another and at a transverse rung distance 36.1 of about 0.5 m.

The vertical frame 25.2 shown in FIG. 2, also called a standard or normal or regular frame 25.2, has precisely two straight vertical supports 30.3 and 30.4, each having the same length 92.2. The length 92.2 corresponds to the effective length of the vertical frame 25.2 or its vertical supports 30.3, 30.4. The length 92.2 is slightly smaller than the horizontal distance 31 between the two vertical supports 30.3, 30.4 or between the longitudinal axes 32.2, 32.2 of these two vertical supports 30.3 and 30.4. The length 92.2 of each of these vertical supports 30.3, 30.4 amounts to about 100 cm or about 1.0 m. The weight of this vertical or standard frame 25.2 amounts to only about 18 kg.

In contrast to the vertical frame 25.1 shown in FIG. 4, the vertical frame 25.2 shown in FIG. 2 has only a single perforated disk 45.1, 45.2 per vertical support 30.3 or 30.4, in each instance. In this connection, the perforated disk 45.1, 45.2, in each instance, is disposed in the region of the upper end 33.1, 33.2, in each instance, of the vertical support 30.3 and 30.4, in each instance, specifically at a distance 93.1 from the upper end 33.1, 33.2, in each instance, that amounts to about 10 cm or about 0.1 m here. While both horizontal arms 35.1 and 35.2 are provided with connecting heads 50.1, 50.2 in the case of the vertical frame 25.1 shown in FIG. 4, each of which heads are set onto a related perforated disk 45.1, 45.2, 45.3, 45.4 with their slits 58, in each instance, and are welded onto the vertical support 30.1, 30.2, in each instance, in this set-on position, and preferably also onto the perforated disk 45.1, 45.2, 45.3, 45.4, in each instance, in the case of the vertical frame 25.2 shown in FIG. 2, only the upper horizontal arm 35.3 has two connecting heads 50.1, 50.2, which is set onto the perforated disk 45.1, 45.2, in each instance, with its slit 58, in each instance, and welded onto the vertical support 30.3, 30.4, in each instance, in this set-on position, and preferably also onto the perforated disk 45.1, 45.2, in each instance. The other, lower horizontal arm 35.4 of the two horizontal arms 35.3, 35.4 of the vertical frame 25.2 is directly welded to the vertical support 30.3 and 30.4, in each instance, in other words without any perforated disks 45 lying in between. The said lower horizontal arm 35.4 accordingly also does not have any corresponding connecting heads 50. It is practical if the ends of the horizontal arm 35.4 are hollowed out with a radius that corresponds to the outer radius of the vertical supports 30.3 and 30.4, and welded to the vertical support 30.3 and 30.4, in each instance, with a preferably continuous, i.e. full-circumference weld seam, in the region of its two hollowed-out ends. This horizontal arm 35.4 or its longitudinal axis 37.4 is disposed at a distance 36.2 below and parallel to the other, upper horizontal arm 35.3 or its longitudinal axis 37.3, whereby this distance 36.2 amounts to about 50 cm or about 0.5 m. The distance 36.2 is therefore about half as great as the effective length 92.2 of the vertical frame 25.2 or of its vertical supports 30.3, 30.4. The two horizontal arms 35.3 and 35.4 form two transverse rungs 35 of a ladder 21 in the constructed scaffold 20. Accordingly, the horizontal arms 35.3 and 35.4 are attached to the vertical supports 30.3 and 30.4, parallel to one another and at a transverse rung distance 36.2 that amounts to about 0.5 m. The horizontal arm 35.4 or its longitudinal axis 37.4 has a distance 41.2 from the lower end 34.1, 34.2 of the vertical supports 30.3, 30.4, in each instance, that amounts to precisely 397 mm here, or about 0.4 m. Accordingly, the lower horizontal arm 35.4 of the vertical frame 25.2 is attached to the vertical supports 30.3, 30.4 about in the region of the vertical center of the vertical frame 25.2, between the upper and lower ends 33.1, 33.2; 34.1, 34.2 of these supports, and extends perpendicular to them, between them.

The vertical frame 25.2 is provided with two pipe connectors 105 that are non-releasably connected with the vertical supports 30.3, 30.4, at their lower ends 34.1, 34.2, preferably in one piece. Preferably, the pipe connectors 105 have been or are produced by means of forming the vertical supports 30.3, 30.4. It is understood, however, that the pipe connectors can also be pipe parts that can partly be inserted into the lower ends of the vertical supports, which are configured as pipes, and can be non-releasably attached to them by way of or by means of a press connection. The two pipe connectors 105 project beyond the lower ends 34.1, 34.2 of the vertical supports 30.3, 30.4, respectively beyond the abutting edges 65 provided there, with a length 108. This length 108 preferably amounts to about 10 to 20 cm, particularly about 15 to 17 cm, preferably precisely 165 mm, whereby a bevel is preferably present at the free end, the length of which preferably amounts to precisely 15 mm. Using the pipe connectors 105, the vertical frames 25.2 can be set onto other vertical frames, in other words particularly onto the starting frames 25.1 or on other vertical frames 25.2, 25.3. The pipe connectors 105 therefore form part of a plug-in connection 102. The pipe connectors 105 have an outside diameter 106 that is slightly smaller than the inside diameter of the upper ends 33.1, 33.2 of the vertical supports 30, so that the pipe connectors 105 can be inserted there. If a vertical frame 25.2 according to the invention is set onto another vertical frame 25, for example as shown in FIG. 1, a coupling or abutment location 60 is formed, in each instance, in the region of the plug-in connection 102, in each instance. There, the vertical frames 25 that are set onto one another can be separated from one another. This coupling or abutment location 60 is disposed, in each instance, at a relatively slight distance 93.1, preferably amounting to only about 0.1 m, above the upper horizontal arm 35, in each instance, or above the upper transverse rung 35, in each instance, particularly above the longitudinal axis 37 of this arm or rung.

The vertical frame 25.3 particularly shown in FIG. 3, also called an equalization frame 25.3, has precisely two straight vertical supports 30.5 and 30.6, each having the same length 92.3. The length 92.3 corresponds to the effective length of the vertical frame 25.3 or its vertical supports 30.5, 30.6. The length 92.3 is less than the horizontal distance 31 between the two vertical supports 30.3, 30.4 or between the longitudinal axes 32.2, 32.2 of these two vertical supports 30.5 and 30.6. The effective length 92.3 is half as great as the effective length of the vertical frame 25.2 shown in FIG. 2. The length 92.3 of each of these vertical supports 30.5, 30.6 therefore preferably amounts to about 50 cm or about 0.5 m. The weight of this vertical frame 25.3 amounts to only about 13 kg.

In the same manner as in the case of the vertical or standard frame 25.2 shown in FIG. 2, and consequently again in contrast to the vertical or starting frame 25.1 shown in FIG. 4, the vertical or equalization frame 25.3 shown in FIG. 3 has only a single perforated disk 45.1, 45.2, in each instance, per vertical support 30.5 or 30.6. In this connection, the perforated disk 45.1, 45.2, in each instance, is disposed in the region of the upper end 33.1, 33.2, in each instance, of the vertical support 30.5 and 30.6, in each instance, specifically at a distance 93.1 from the upper end 33.1, 33.2, in each instance, that amounts to about 10 cm or 0.1 m here. In the case of the vertical frame 25.3 shown in FIG. 3, also, only the upper horizontal arm 35.5 has two connecting heads 50.1, 50.2, which is set onto the perforated disk 45.1, 45.2, in each instance, with its slit 58, in each instance, and welded onto the vertical support 30.5, 30.6, in each instance, in this set-on position, and preferably also onto the perforated disk 45.1, 45.2, in each instance. The other, lower horizontal arm 35.6 of the two horizontal arms 35.3, 35.4 of the vertical frame 25.3 is directly welded to the vertical support 30.5 and 30.6, in each instance, in other words without any perforated disks 45 lying in between. The said lower horizontal arm 35.6 accordingly also does not have any corresponding connecting heads 50. It is practical if the ends of the horizontal arm 35.6 are hollowed out with a radius that corresponds to the outer radius of the vertical supports 30.5 and 30.6, and welded to the vertical support 30.5 and 30.6, in each instance, with a preferably continuous, i.e. full-circumference weld seam, in the region of its two hollowed-out ends. The lower horizontal arm 35.6, which is preferably configured as a quadragonal profile or quadragonal pipe, or its longitudinal axis 37.6 is disposed at a distance 36.3 below and parallel to the other, upper horizontal arm 35.5 or its longitudinal axis 37.5, whereby this distance 36.3 amounts to about 37 cm or about 0.3 to 0.4 m. The lower horizontal arm 35.6 or its longitudinal axis 37.6 has a distance 41.3 from the lower end 34.1, 34.2, in each instance, of the vertical supports 30.5, 30.6, that amounts to about 25 mm or about 0.02 to 0.03 here.

The vertical or equalization frame 25.3 is also provided with two pipe connectors 105 that are non-releasably connected with the vertical supports 30.5, 30.6, at their lower ends 34.1, 34.2, preferably in one piece. Preferably, the pipe connectors 105 have been or are produced by means of forming the vertical supports 30.5, 30.6. It is understood, however, that these pipe connectors can also be pipe parts that can partly be inserted into the lower ends of the vertical supports, which are configured as pipes, and can be non-releasably attached to them by way of or by means of a press connection. The two pipe connectors 105 project beyond the lower ends 34.1, 34.2 of the vertical supports 30.5, 30.6, respectively beyond the abutting edges 65 provided there, with a length 108. This length 108 preferably amounts to about 10 to 20 cm, particularly about 15 to 17 cm, preferably precisely 165 mm, whereby a bevel is preferably present at the free end, the length of which preferably amounts to precisely 15 mm. Using the pipe connectors 105, the vertical or equalization frames 25.3 can be set onto other vertical frames 25, particularly onto the vertical frames 25.2. The pipe connectors 105 therefore again form part of a plug-in connection 102. The pipe connectors 105 also have an outside diameter 106 that is slightly smaller than the inside diameter of the upper ends 33.1, 33.2 of the vertical supports 30, so that the pipe connectors 105 can be inserted there. If a vertical or equalization frame 25.3 according to the invention is set onto another vertical frame 25, particularly onto a vertical frame 25.2, for example as shown in FIG. 1, a coupling or abutment location 60 is formed, in each instance, in the region of the plug-in connection 102, in each instance. There, the vertical frames 25 that are set onto one another can be separated from one another. This coupling or abutment location 60 is disposed, in each instance, at a relatively slight distance 93.1, preferably amounting to only about 0.1 m, above the upper horizontal arm 35, in each instance, or above the upper transverse rung 35, in each instance, particularly above the longitudinal axis 37 of this arm or rung.

A preferred exemplary embodiment of a method according to the invention, for installation of a scaffold 20 according to the invention, will be described in greater detail in the following, using FIGS. 7.1 to 7.15, and using the example of a one-field scaffold 20 in the form of a falsework or load-bearing scaffold tower 22:

For constructing the scaffold 20 or the load-bearing scaffold tower 22, first a suitable number of foot spindles 29 that allow height or level equalization can be set up on the ground, if necessary on top of supporting plates, as shown in FIG. 7.1.

A starting frame or vertical frame 25.1 can be set onto two of the foot spindles 29, in each instance, as shown in FIG. 7.2. Subsequently, the two starting frames 25.1, 25.1 can be connected with one another by way of two longitudinal or scaffold bars 28.2, 28.2, in that these are set onto the lower perforated disks 45.3, 45.4 of the starting frames 25.1, 25.1, with their connecting heads 250, and subsequently secured there by means of the connecting wedges. Subsequently or previously, the two starting frames 25.1, 25.1 can be connected with one another by way of a horizontal diagonal 23, in that the latter is set, with its connecting heads 250, onto the lower perforated disks 45.3, 45.4 of the starting frames 25.1, 25.1, and subsequently secured there by means of the connecting wedges. In this manner, a closed horizontal base frame consisting of five scaffold components here, namely the two parallel longitudinal bars 28.2, 28.2, the two horizontal arms or transverse rungs 35.2 of the two starting frames 25.1, 25.1, disposed perpendicular to them, in each instance, and the horizontal diagonal 23, can be constructed. The scaffold bars 28.2, 28.2 span a horizontal plane in which the horizontal diagonal 23 also extends.

As shown in FIG. 7.3, the base frame or the scaffold 20 can be aligned horizontally, in other words perpendicular to the vertical, using a level that the installer 63 is holding in his hands there, particularly in that the scaffold components are brought to the desired level by way of the foot spindles 29. Subsequently, the installer 63 can attach two further scaffold bars 28.2, 28.2 to the upper perforated disks 45.1, 45.2 of the starting frame 25.1, 25.1, by way of their connecting heads 250, and, subsequently or previously, can attach two vertical diagonals 24.1 to an upper perforated disk 45.1 or 45.2, in each instance, of the one starting frame 25.1 and to a lower perforated disk 45.3 or 45.4 of the other starting frame 25.1, by way of their connecting heads 150, as shown in FIG. 7.4. In this manner, a sort of basic cage having two horizontal and four lateral, vertical cage planes can therefore be constructed.

Preferably subsequently, the scaffold components of this basic cage are rigidly connected with one another, in that the installer 63 wedges the four scaffold bars 28.2 and the horizontal diagonal 23 as well as the two vertical diagonals 24.1 in place on the vertical supports 30.3, 30.4 or on the perforated disks 45 of the starting frames 25.1, 25.1, for example using a hammer, not shown, by means of a blow on the upper ends of the through-hole wedges of the connecting heads 250 and 150. In this way, a rigid basic frame in the form of a three-dimensional rod support structure, which is secured in all horizontal and vertical planes and also against torsion, is obtained, and the scaffold 20 can be constructed further, based on this.

As shown in FIG. 7.5, the installer 63 standing on the ground can lay or suspend multiple, for example four floor plates 43 by means of their suspension hooks 44 on top of or on the two upper scaffold bars 28.1, 28.1, so that then, the two upper scaffold bars 28.1, 28.1 serve as floor plate support elements 62.1, 62.2, which define attachment positions 61 for the floor plates 43. The floor plates 43 laid on in this vertical region 101.2 form a first support surface or work level, to which the installer 63 can climb from the ground.

Subsequent to laying the floor plates 43 onto the two upper scaffold bars 28.1, 28.1, the installer 63, as shown in FIG. 7.6, while still standing on the ground, can set vertical or standard frames 25.2 onto each of the two starting frames 25.1, 25.1, in each instance. For this purpose, the installer 63 can insert the standard or vertical frame 25.2, in each instance, into the upper pipe ends 33.1, 33.2 of the vertical supports 30.1, 30.2 of one of the starting or vertical frames 25.1 that has already been constructed, with its lower pipe connectors 105, until the standard or vertical frame 25.2, in each instance, sits on the coupling or abutment location 60 on the upper face edge of the vertical support 30.1, 30.2, in each instance, with its abutting edges 65. After the standard frame 25.2, in each instance, has been set onto the starting frame 25.1, in each instance, a ladder 21.1 or 21.2 is automatically obtained, which has four transverse rungs here, namely the two transverse rungs 35.1 and 35.2 of the starting frame 25.1, in each instance, also called horizontal arms, and the two transverse rungs 35.3 and 35.4 of the standard frame 25.2, in each instance, likewise also called horizontal arms. At least one of the ladders 21.1 of these ladders 21.1, 21.2 can be used as an aid for climbing up and climbing down, for further installation, if applicable also for subsequent removal of the scaffold 20.

After the two standard frames 25.2 have been set on, the installer 63 can either, as shown in FIG. 7.7, still standing on the ground, attach two further scaffold bars 28.2, 28.2 to the perforated disks 45.1, 45.2 that define specific attachment positions, particularly for the scaffold bars 28.2 of the two standard frames 25.2, 25.2 that are disposed at essentially the same height and have already been set onto the standard frame 25.1, 25.1, in each instance, by way of their connecting heads 250, at these perforated disks 45.1, 45.2. These perforated disks 45.1, 45.2 of the standard frame 25.2 that has been set on, in each instance, and consequently the further scaffold bars 28.2, 28.2 attached to these perforated disks 45.1, 45.2 have a vertical distance 97 (see FIG. 1) from the perforated disks 45.1, 45.2 of the starting frame 25.1, 25.1, in each instance, which is situated underneath, and consequently from the scaffold bars 28.2, 28.2 attached to them, which corresponds to the effective length 92.2 of the standard frame 25.2, in each instance, or of its vertical supports 30.3, 30.4, and which here therefore amounts to about 100 cm or about 1 m. Accordingly, the scaffold bars 28.2, 28.2 attached to the perforated disks 45.1, 45.2 of the set-on standard frame 25.2, in each instance, are at a vertical distance above floor plates 43 that lie on the scaffold bars 28.2, 28.2 attached to the two perforated disks 45.1, 45.2 of the starting frame 25.1, 25.1, in each instance, which distance also approximately corresponds to the effective length 92.2 of the standard frames 25.2 or their vertical supports 30.3, 30.4, and which consequently also amounts to about 100 cm or about 1 m. In this manner, the longitudinal or scaffold bars 28.2, 28.2 attached to the perforated disks 45.1, 45.2 of the set-on standard frame 25.2, in each instance, form hip and/or back railing elements 62.1, 62.2 for a person or for an installer 63, when this person or installer is standing on the floor plates 43 that lie underneath, in the vertical region 101.2, as is shown, for example, in FIGS. 7.8 to 7.10.

Subsequent to attaching the scaffold bars 28.2, 28.2 to the set-on standard frame 25.2, 25.2, in each instance, or also previously, the installer 63, as shown in FIG. 7.7, while still standing on the ground, can install preferably two vertical diagonals 24.2, 24.2, in that he attaches them, in each instance, between the two horizontally adjacent standard frames 25.2, 25.2, which are disposed essentially at the same height, to their perforated disks 45, in such a manner that each vertical diagonal 24.2 is attached to a perforated disk 45.1 or 45.2 of one of the two set-on standard frames 25.2 with its connecting head 150, at one end, and to a perforated disk 45.1 or 45.2 of a starting frame 25.1 that lies underneath, with its connecting head 150, at the other end, specifically, once again, as was already the case with the vertical diagonals 24.1 of the first height block 100.1, disposed crosswise relative to one another, in each instance. In this or a similar manner, the installer 63, while still standing on the ground, can construct a second height block 100.2, which contains the two set-on standard frames 25.2, 25.2, on the first height block 100.1.

Subsequently, the installer 63 can climb up from the ground to the floor plates 43 of the first height block, so that subsequently, as shown in FIG. 7.8, while standing on the floor plates 43, he is situated within an interior 83 that is preferably secured in cage-like manner, on all sides, circumferentially, to prevent persons 63 from falling down to the side, with the leading installed hip and/or back railings, specifically not only in the form of the two longitudinal or scaffold bars 28.2, 28.2, but also in the form of the two horizontal arms or transverse rungs 35.3, 35.3, of the two set-on standard frames 25.2, 25.2, which are disposed at essentially the same height as these, but perpendicular to them. Optimally secured, in this manner, to prevent falling down to the side, the installer 63 standing on the floor plates 43 of the vertical region 101.2 can now, as also illustrated in FIG. 7.8, set two further vertical or standard frames 25.2, 25.2 onto the standard frames 25.2, 25.2 of the second height block 100.2 that have already been constructed or set on. In this manner, the ladder 21.1, 21.2, in each instance, is expanded upward, by the two horizontal arms or transverse rungs 35.3 and 35.4 of the further set-on vertical or standard frame 25.2, 25.2, in each instance.

Subsequently, the installer 62 standing on the floor plates 43 of the vertical region 101.2, can continue to construct the third height block 100.3 formed by the two further standard frames 25.2, 25.2 that were previously set on. For this purpose, the installer 63 can complete a leading railing for a next vertical region 101.4, in such a manner that he attaches two further scaffold bars 28.2, 28.2, as shown in FIG. 7.9, to the perforated disks 45.1, 45.2 of the further set-on standard frame 25.2, 25.2, in each instance, between the two said further standard frames 25.2, 25.2, in each instance, which are disposed at essentially the same height, at their perforated disks 45.1 or 45.2, in each instance.

Subsequently or previously, the installer 63 can also vertically reinforce this height block 100.3, using two further vertical diagonals 24.2, 24.2, as is also illustrated in FIG. 7.9. Subsequent to this, the installer 93, as is evident from a comparison of FIGS. 7.9 and 7.10, can remove all the other floor plates 43 of the vertical region 101.2, preferably with the exception of one floor plate 43, and install them again in the scaffold 20 that is under construction, in such a manner that he installs the removed floor plates 43 again in the next higher vertical region 101.3, in other words lays them onto the two scaffold bars 28.2, 28.2 of the said next higher vertical region 100.3, which serve as hip and/or back railings in this connection. These scaffold bars 28.2, 28.2 then therefore also serve as floor plate support elements 60.1, 60.2. For this purpose, it is practical if the installer 63 covers the scaffold bars 28.2, 28.2 of the said next higher vertical region 101.3 with the floor plates 43 that have been removed underneath, in such a manner that finally, an opening 76 remains at hip height or at the height of the newly installed floor plates and between a floor plate 43 of the newly reinstalled floor plates 43 and the transverse rung 35.3 of a vertical or standard frame 25.2 of the second height block 100.2, in which opening the installer 63 is situated, standing on at least one floor plate 43 remaining in the vertical region 101.2 that lies underneath.

Proceeding from this, the installer 63, as illustrated in FIG. 7.11, can subsequently climb further up, from the remaining lower floor plate 43, by way of the transverse rungs 35 of the ladder 21.1, through the opening 76 that then serves as a pass-through opening, to the floor plates 43 of the said next higher vertical region 101.3. There, the installer 63 is then again optimally secured to prevent falling down to the side, circumferentially, by a multi-part hip and/or back railing that is formed from two transverse bars 28.2, 28.2 and two transverse rungs 35.3, 35.3. The installer can now have the one floor plate 43 for the uppermost work platform, on which the installer 63 is present, which plate is still missing, handed to him from below by a further person, not shown, whereupon he can install or installs the floor plate 43 that is still missing there, as shown in FIG. 7.12. Subsequently, in this exemplary embodiment and in this installation stage, five floor plates 43 have been mounted or installed, in total, namely the one floor plate 43 remaining in the vertical region 101.2 and the four floor plates 43 installed in the vertical region 101.3 that lies above it.

Depending on the desired or required height of the scaffold 20 to be constructed, the set-up or installation process described above can be continued in the same or similar manner, particularly in that first, further vertical or standard frames 25.2 are constructed, in pairs, per vertical region 101 or per height block 100, and, assigned to these, further scaffold bars 28.2 as well as vertical diagonals 24.2, for example until the structure shown in FIG. 7.13 has been reached. As is evident, three additional vertical regions 101.4 to 101.6 or three additional height blocks 100.4 to 100.6 have been constructed there, proceeding from the installation situation shown in FIG. 7.12, whereby of these, two vertical regions 101.4 and 101.5 were equipped with floor plates 43 during the course of the further construction. In the case of the scaffold structure shown in FIG. 7.13, seven floor plates 43, in total, have been mounted or installed, of which four floor plates 43 are installed in the uppermost work or structure plane and consequently in the vertical region 101.5, and of which one floor plate 43, in each instance, is installed in the vertical regions 101.4, 101.3, and 101.2 that lie underneath, in each instance. These individual floor plates 43 installed one on top of the other, in tier-type manner, are mounted vertically one above the other. In this manner, the installer 63 can implement the construction or the installation of the scaffold 20 by way of one and the same ladder 21.1, which “continues to grow” as the construction progresses.

As is also illustrated in FIG. 7.13, the installer 63, standing on the floor plates 43 of the uppermost work or construction level of the vertical region 101.5, can set an equalization frame 25.3, in each instance, onto one of the standard frames 25.2, 25.2 that have already been set on, in each instance, as a final frame. These two equalization frames 25.3, 25.3 are in turn constructed at essentially the same height, at a horizontal distance from one another that corresponds to the length of the scaffold bars 28.2. The two equalization frames 25.3, 25.3 are part of a final height block 100.6. This can furthermore also be reinforced with two vertical diagonals 24.1, 24.1, in each instance, as well as with an upper horizontal diagonal 23 that the installer 63, standing on the floor plates 43 of the uppermost work or construction level of the vertical region 101.5, can install there. As a final step or previously, the installer 63, also from there, can a head spindle 38, for example provided with a U profile 38.1 that is open toward the top, can additionally be set on or inserted into the free pipe ends 33.1, 33.2 of the vertical supports 30.5, 30.6 of the equalization frames 25.3, 25.3, which ends project upward. The U profile 38.1 can be provided for laying on or accommodating load carriers or formwork carriers, here in the form of I beams 26 (see FIG. 1 as well as 7.14 and 7.15). It is understood that the same or other head spindles can also be configured to be adapted to support and/or accommodate other support bodies, for example in the form of cross-head spindles, in which a support plate and multiple support profiles, spaced horizontally apart and extending upward proceeding from the plate, can be provided in the region of their upper ends.

During the course of climbing down from the finished, constructed scaffold 20 or load-bearing scaffold tower 22, preferably by way of the ladder 21.1, the installer 63 can take off the floor plates 43 of the uppermost work or construction level, and pass them down or take them down with him. The installer 43, as shown in FIG. 7.15, can remove the two remaining individual floor plates 43 of the two vertical regions 101.3 and 101.2 that are close to the ground, while standing on the ground.

To disassemble the scaffold 20 or the load-bearing scaffold tower 22 from which the floor plates 43 were removed, a crane or similar hoist can be used, in order to allow disassembly while it is lying down. Alternatively, it is also easily possible to disassemble the scaffold 20, for example as described above, in the reverse order, so that in this way, standing disassembly is also possible.

It is understood that the invention is not restricted to the exemplary embodiments shown in the figures and described above, but rather, a scaffold according to the invention and/or a method for its installation and/or a method for its removal can also be configured, dimensioned, structured, installed and/or implemented in different manner, within the scope of the idea of the invention.

### REFERENCE SYMBOL LIST

20 scaffold, load-bearing scaffold, falsework
21 ladder
21.1 ladder
21.2 ladder
22 load-bearing scaffold tower, falsework tower, load tower
23 horizontal diagonal
24.1 vertical diagonal
24.2 vertical diagonal
25 vertical frame
25.1 vertical frame, starting frame
25.2 vertical frame, regular, normal, standard frame
25.3 vertical frame, equalization frame
26 I-beam
27.1 connecting element, scaffold bar
27.2 connecting element, transverse bar
28.2 connecting element, longitudinal bar
29 foot spindle
30 vertical support
30.1 first vertical support
30.2 second vertical support
30.3 first vertical support
30.4 second vertical support
30.5 first vertical support
30.6 second vertical support
31 horizontal distance
32 longitudinal axis of 30
32.1 longitudinal axis of 30.1, 30.2
32.2 longitudinal axis of 30.3, 30.4
32.3 longitudinal axis of 30.5, 30.6
33 upper end of 30
33.1 upper end of 30.1, 30.3, 30.5
33.2 upper end of 30.2, 30.4, 30.6
34 lower end of 30
34.1 lower end of 30.1, 30.3, 30.5
34.2 lower end of 30.2, 30.4, 30.6
35 horizontal arm
35.1 first horizontal arm/transverse rung
35.2 second horizontal arm/transverse rung
35.3 first horizontal arm/transverse rung
35.4 second horizontal arm/transverse rung
35.5 first horizontal arm
35.6 second horizontal arm/quadragonal profile
36 vertical distance
36.1 vertical distance/transverse rung distance
36.2 vertical distance/transverse rung distance
36.3 vertical distance/transverse rung distance
36.4 vertical distance/transverse rung distance
37 longitudinal axis of 35
37.1 longitudinal axis of 35.1
37.2 longitudinal axis of 35.2
37.3 longitudinal axis of 35.3
37.4 longitudinal axis of 35.4
37.5 longitudinal axis of 35.5
37.6 longitudinal axis of 35.6
38 head spindle
38.1 U profile
39.1 vertical frame arrangement
39.2 vertical frame arrangement
40 diagonal rod
40.1 diagonal rod/corner reinforcement
40.2 diagonal rod/corner reinforcement
40.3 diagonal rod/corner reinforcement
40.4 diagonal rod/corner reinforcement
40.5 diagonal rod/corner reinforcement
40.6 diagonal rod/corner reinforcement
41.1 distance
41.2 distance
41.3 distance
42 flat connector
43 floor plate/scaffold floor
44 suspension hook
45 attachment position/perforated disk
45.1 attachment position/first perforated disk
45.2 attachment position/second perforated disk
45.3 attachment position/third perforated disk
45.4 attachment position/fourth perforated disk
46 perforation
46.1 small perforation
46.2 large perforation
47 horizontal strut
47.1 horizontal strut
47.2 horizontal strut
47.3 horizontal strut
48.1 vertical frame support
48.2 vertical frame support
49 post and disk center
50 connecting head
50.1 first connecting head
50.2 second connecting head
51.1 upper side wall part
51.2 upper side wall part
52.1 lower side wall part
52.2 lower side wall part
53.1 upper vertical outer surface
53.2 upper vertical outer surface
54.1 lower vertical outer surface
54.2 lower vertical outer surface
55 wedge angle
56 upper head part
57 lower head part
58 slit
59.1 upper contact wall part
59.2 lower contact wall part
60 coupling/abutment location
61 attachment position
62.1 hip and/or back railing element or floor plate support element
62.2 hip and/or back railing element or floor plate support element
63 person
64 wedge
65 abutting edge
66.1 upper horizontal slit surface
66.2 lower horizontal slit surface
67 vertical slit surface
68 (longitudinal) distance
69.1 liquid outflow opening
69.2 liquid outflow opening
70 slit width
71 horizontal plane
72 center plane of 30
73 longitudinal axis of 40
73.1 longitudinal axis of 40.1
73.2 longitudinal axis of 40.2
73.3 longitudinal axis of 40.3
73.4 longitudinal axis of 40.4
73.5 longitudinal axis of 40.5
73.6 longitudinal axis of 40.6
74 angle
74.1 angle
74.2 angle
75.1 vertical center axis
75.2 vertical center axis
75.3 vertical center axis
76 climb-through opening/opening
77.1 upper outer surface
77.2 lower outer surface
78.1 angle
78.2 angle
80.1 upper contact surface
80.2 lower contact surface
81.1 upper end
81.2 lower end
82 vertical plane
83 interior
85 distance
85.1 distance
85.2 distance
85.3 distance
86 wall thickness of 30, 47
87 wall thickness of 40
88 circumference angle
89 perforated disk part
90 connecting node
91 double hole
92.1 effective length of 30.1, 30.2
92.2 effective length of 30.3, 30.4
92.3 effective length of 30.5, 30.6
93.1 distance
93.2 distance
93.3 distance
93.4 distance
94.1 outside diameter of 30.1 to 30.6
94.2 outside diameter of 47.1
94.3 height/thickness of 47.3
94.4 outside diameter of 47.2
95 outside diameter of 40
97 (vertical) distance
100 height block
100.1 (starting) height block
100.2 (normal/regular/standard) height block
100.3 (normal/regular/standard) height block
100.4 (normal/regular/standard) height block
100.5 (normal/regular/standard) height block
100.6 (equalization) height block
101.1 vertical region
101.2 vertical region
101.3 vertical region
101.4 vertical region
101.5 vertical region
101.6 vertical region
102 plug-in connection
105 pipe connector
106 outside diameter of 105
108 length
115 insertion end of 105
124 length
150 connecting head
158 slit
250 connecting head
258 slit

1-22. (canceled)

23. Scaffold that is constructed of at least four vertical frames (25.2), specifically of a first vertical frame (25.2), a second vertical frame (25.2), a third vertical frame (25.2), and a fourth vertical frame (25.2), wherein each of these vertical frames (25.2) comprises at least two parallel vertical supports (30.3, 30.4), which are disposed at a horizontal distance (31) from one another, and on which perforated disks (45; 45.1, 45.2) provided with multiple perforations (46.1, 46.2) are attached, in non-releasable manner, by means of welding, for connecting holding devices, wherein one perforated disk (45.1, 45.2) of the perforated disks (45; 45.1, 45.2), in each instance, is attached to every vertical support (30.3, 30.4), and wherein each vertical frame (25.2) of the at least four vertical frames (25.2) comprises at least two parallel horizontal arms (35.3, 35.4), which are disposed at a vertical distance (36.2) from one another, and which extend, in each instance, between the at least two vertical supports (30.3, 30.4) of the vertical frame (25.2), in each instance, perpendicular to these vertical supports (30.3, 30.4), and are attached to them, with their ends, by means of welding, and wherein the third vertical frame (25.2) is set onto the first vertical frame (25.2), and the fourth vertical frame (25.2) is set onto the second vertical frame (25.2), wherein the first vertical frame (25.2) and the second vertical frame (25.2) are disposed at essentially the same height, at a horizontal distance (68) from one another, and form a part of a first height block (100.2, 100.3, 100.4) of the scaffold (20) in a first vertical region (101.2, 101.3, 101.4), and wherein the third vertical frame (25.2) and the fourth vertical frame (25.2) form a part of a next, second height block (100.3, 100.4, 100.5) in a next-higher, second vertical region (101.3, 101.4, 101.5), and are disposed at essentially the same height at the horizontal distance (68) from one another, so that the first vertical frame (25.2) and the third vertical frame (25.2) form a first vertical frame arrangement (39.1) in the form of a first vertical frame support (48.1), and the second vertical frame (25.2) and the fourth vertical frame (25.2) form a second vertical frame arrangement (39.2) disposed at the horizontal distance (68) from the first vertical frame support (48.1), in the form of a second vertical frame support (48.2), and wherein at least two connecting elements (28.2) that extend essentially horizontally and are configured as connecting rods (28.2) are provided, which are configured, in each instance, as a single connecting rod (28.2), wherein a first connecting rod (28.2) of the connecting rods (28.2) in the first height block (100.2, 100.3, 100.4) extends between two vertical supports (30.3, 30.3; 30.4, 30.4) of the horizontally adjacent vertical frames (25.2) of this first height block (100.2, 100.3, 100.4), disposed at the horizontal distance (68) relative to one another, and is releasably attached, with its ends, to the perforated disks (45; 45.1, 45.2) of these vertical supports (30.3, 30.3; 30.4, 30.4), which form attachment positions, and are disposed at essentially the same height, and wherein a second connecting rod (28.2) of the connecting rods (28.2) extends in the next, second height block (100.3, 100.4, 105), between two vertical supports (30.3, 30.3; 30.4, 30.4) of the horizontally adjacent vertical frames (25.2) of this second height block (100.2, 100.3, 100.4), disposed at the horizontal distance (68) from one another, and, with its ends, is releasably attached, parallel to the first connecting rod (28.1), to the perforated disks (45; 45.1, 45.2) of these vertical supports (30.3, 30.3; 30.4, 30.4) that form the attachment positions, at essentially the same height,
wherein:
a) in the first vertical region (101.2, 101.3, 101.4) and in the next-higher, second vertical region (101.3, 101.4, 101.5) of vertical regions (101.2, 101.3, 101.4, 101.5) of the scaffold (20) disposed one above the other, floor plates (43) are releasably affixed at attachment positions (61);
b) at least one first connecting rod (28.2) of the at least two connecting rods (28.2, 28.2) serves, at least during installation of the scaffold (20), in the first vertical region (101.2, 101.3, 101.4), as a first hip and/or back railing element (62.1, 62.2) for protection to prevent a person (63) from falling down, and at least a second connecting rod (28.2) of the at least two connecting rods (28.2, 28.2) serves, at least during installation of the scaffold (20), in the next-higher, second vertical region (101.3, 101.4, 101.5), as a second hip and/or back railing element (62.1, 62.2), for protection against a person (63) falling down;
c) the vertical supports (30.3, 30.4) of the at least two vertical frames (25.2) that belong to the first vertical region (101.2, 101.3, 101.4), of the at least four vertical frames (25.2, 25.2), and the vertical supports (30.3, 30.4) set onto the vertical supports (30.3, 30.4) of the at least two further vertical frames (25.2) of the at least four vertical frames (25.2, 25.2) that already belong to the next-higher, second vertical region (101.3, 101.4, 101.5), also have the same effective length (92.2), which amounts to between 80 cm and 120 cm, or which amounts to about 100 cm, and which essentially corresponds to the vertical distance (97) between the perforated disks (45; 45.1, 45.2) of the first and of the second vertical frame (25.2), which are essentially disposed at the same height, on which the first connecting rod (28.2) which serves as the first hip and/or back railing element (62.1, 62.2), is releasably attached, of the perforated disks (45; 45.1, 45.2) of the third and of the fourth vertical frame (25.2), disposed at essentially the same height, on which the second connecting rod (28.2), which serves as a second hip and/or back railing element (62.1, 62.2), is releasably attached, so that in every vertical region (101.2, 101.3, 101.4, 101.5) of the said vertical regions (101.2, 101.3, 101.4, 101.5) equipped with at least one floor plate (43) of the floor plates (43), a hip and/or back railing formed from a connecting rod (28.2), in each instance, of the connecting rods (28.2), is implemented, which railing has a vertical distance from the floor plate (43) of the floor plates (43) that lies beneath it, in each instance, which distance also amounts to between 80 cm and 120 cm or which also amounts to about 100 cm;
d) the second connecting rod (28.2) that is provided as a second hip and/or back railing element (62.1, 62.2) can be moved upward, during installation of the scaffold (20), from a first vertical region (101.2, 101.3, 101.4) of the scaffold (20), which has already been completed, in other words already formed with at least one floor plate (43) of the floor plates (43), with the first vertical frame (25.2), with the second vertical frame (25.2), and with the first connecting rod (28.2) that serves as a first hip and/or back railing element (62.1, 62.2), and that has a vertical distance from the floor plate (43) that lies beneath it, which distance amounts to between 80 cm and 120 cm or which amounts to about 100 cm, on the perforated disks (45; 45.1, 45.2) of the vertical frame (25.2) that already belongs to the next-higher, second vertical region (101.3, 101.4, 101.5) of the scaffold (20), already set onto the assigned vertical frame (25.2), in each instance, of the first vertical region (101.2, 101.3, 101.4) that lies underneath, by a person (63) standing on the floor plate (43) of the already finished first vertical region (101.2, 101.3, 101.4) or on the ground, by means of directly grasping it, and can be fixed in place there, on the perforated disks (45; 45.1, 45.2) of the vertical frames (25.2) that have been set on;
e) the horizontal arms (35.3, 35.4) of the vertical frames (25.2) of the first vertical frame support (48.1), which are set onto one another, form transverse rungs (35.3, 35.4) of a first ladder (21.1) for allowing a person (63) to climb up, and the horizontal arms (35.3, 35.4) of the vertical frames (25.2) of the second vertical frame support (48.2), which are set onto one another, form transverse rungs (35.3, 35.4) of a second ladder (21.2) for allowing a person (63) to climb up, wherein an uppermost transverse rung (35.3) of the first vertical frame (25.2) has a vertical rung distance (36.4), from a bottommost transverse rung (35.4) of the third vertical frame (25.2) that already belongs to the next-higher, second vertical region (101.3, 101.4, 101.5), and is already set onto the first vertical frame (25.2) of the first vertical region (101.2, 101.3, 101.4) that lies underneath, that essentially corresponds to the vertical distance (36.2) between the transverse rungs (35.3, 35.4) of the individual vertical frames (25.2, 25.2), so that all the adjacent transverse rungs (35.3, 35.4) of the first ladder (21.1) essentially have the same vertical transverse rung distances (36.2, 36.4) relative to one another, and wherein an uppermost transverse rung (35.3) of the second vertical frame (25.2) has a vertical rung distance (36.4), from a bottommost transverse rung (35.4) of the fourth vertical frame (25.2) that already belongs to the next-higher, second vertical region (101.3, 101.4, 101.5), and is already set onto the second vertical frame (25.2) of the second vertical region (101.2, 101.3, 101.4) that lies underneath, that essentially corresponds to the vertical distance (36.2) between the transverse rungs (35.3, 35.4) of the individual vertical frames (25.2, 25.2), so that all the adjacent transverse rungs (35.3, 35.4) of the second ladder (21.1) essentially have the same vertical transverse rung distances (36.2, 36.4) relative to one another.

24. Scaffold according to claim 23, wherein at least two of the connecting rods (28.2) that serve as a hip and/or back railing element are disposed at essentially the same height in every vertical region (101.2, 101.3, 101.4, 101.5) of the vertical regions (101.2, 101.3, 101.4, 101.5).

25. Scaffold according to claim 23, wherein the vertical supports (30.3, 30.4) of the vertical frames (25.2, 25.2) that are set onto one another can be separated from one another in the region of that perforated disk (45; 45.1, 45.2), on which the connecting rod (28.2), in each instance, that serves as a hip and/or back railing element (62.1, 62.2) is attached in the vertical region (101.2, 101.3, 101.4, 101.5), in each instance.

26. Scaffold according to claim 23, wherein the vertical frames (25.2), in each instance, are structured to be symmetrical to their center vertical axis (75.2).

27. Scaffold according to claim 23, wherein the transverse rung distance (36.2, 36.4) amounts to half the effective length (92.2) of the vertical frames (25.2), in other words to 40 cm to 60 cm or about 50 cm.

28. Scaffold according to claim 23, wherein at least one transverse rung (35.4) of the transverse rungs (35.3, 35.4) of the vertical frame (25.2, 25.2), in each instance, is reinforced by means of two corner reinforcement elements (40.3, 40.4) that extend diagonally, in each instance, between the said transverse rung (35.4) and, in each instance, one of the vertical supports (30.3, 30.4) of this vertical frame (25.2), and upward or downward, in each instance, from the said transverse rung (35.4).

29. Scaffold according to claim 23, wherein the vertical supports (30.3, 30.4) of the vertical frames (25.2) are coupled with one another by means of plug-in connections (102), to form the vertical frame support (48.1, 48.2), in each instance.

30. Scaffold according to claim 29, wherein the vertical supports (30.3, 30.4) of the vertical frames (25.2) have a push-on element or a plug-in element at one of their ends, in each instance, by means of which the vertical supports (30.3, 30.4) of a vertical frame (25.2) of the vertical frames (25.2) are set onto the vertical supports (30.1, 30.2, 30.3, 30.4) of another vertical frame (25.2, 25.2) of the vertical frames (25.2).

31. Scaffold according to claim 23, comprising the following additional characteristics:
a) at least one transverse rung (35.3) of the transverse rungs (35.3, 35.4) of each vertical frame (25.2) comprises a horizontal strut (47.1) that is connected, at its ends that face away from one another, in one piece or in multiple pieces, in each instance, with a connecting head (50.1, 50.2);
b) the connecting head (50.1, 50.2), in each instance, of the said transverse rung (35.3) is delimited with side wall parts (51.1, 51.2, 52.1, 52.2) that have vertical outer surfaces (53.1, 53.2, 54.1, 54.2) that run towards a center (49), in wedge-like manner, which surfaces enclose a wedge angle (55);
c) the connecting head (50.1, 50.2), in each instance, of the said transverse rung (35.3) has an upper head part (56) and a lower head part (57);
d) a slit (58) is provided between the upper head part (56) and the lower head part (57), which slit is open toward the related vertical support (30.3, 30.4);
e) the connecting head (50.1, 50.2), in each instance, of the said transverse rung (35.3) is set, with its slit (58), onto the perforated disk (45; 45.1, 45.2) of the vertical support (30.3, 30.4), in each instance, which disk projects into the slit, at least in part, and is attached to the vertical support (30.3, 30.4), in each instance, and/or to the perforated disk (45; 45.1, 45.2), in each instance, by means of welding.

32. Method for installing a scaffold according to claim 23, comprising the following steps:
a) after completion of the first vertical region (101.2, 101.3, 101.4) that is formed from at least one floor plate (43) of the floor plates (43), the first vertical frame (25.2), the second vertical frame (25.2), and the first connecting rod (28.2) that serves as a hip and/or back railing element (62.1, 62.2), the third vertical frame (25.2) of the next, second vertical region (101.3, 101.4, 101.5) is first set onto the first vertical frame (25.2) of this first vertical region (101.2, 101.3, 101.4), and the fourth vertical frame (25.2) of the next, second vertical region (101.3, 101.4, 101.5) is set onto the second vertical frame (25.2) of the first vertical region (101.2, 101.3, 101.4);
b) subsequently, the second connecting rod (28.2) for the said next, second vertical region (101.3, 101.4, 101.5) is guided upward by a person (63) standing on the ground or on a floor plate (43) of the floor plates (43) of the first vertical region (101.2, 101.3, 101.4) that has already been completed, by means of directly grasping it, and attached there to the perforated disks (45.1, 45.2) of the vertical frame (25.2) that already belongs to the said next, second vertical region (101.3, 101.4, 101.5) and has already been set onto the related vertical frames (25.2, 25.2) of the first vertical region (101.2, 101.3, 101.4) that lies underneath, so that there, the second connecting rod (28.2) then forms a leading hip and/or back railing;
c) subsequently, at least one floor plate (43) of the floor plates (43) for the said next, second vertical region (101.3, 101.4, 101.5) is guided upward, by a person (63) standing on the ground or on a floor plate (43) of the floor plates (43) of the first vertical region (101.2, 101.3, 101.4) that has already been completed, and there affixed on an attachment position (61) for the floor plate (43) that belongs to the first vertical region (101.2, 101.3, 101.4) that has already been completed, at a vertical distance of 80 cm to 120 cm or of about 100 cm below the hip and/or back railing formed with the second connecting rod (28.2) in the second vertical region (101.3, 101.4, 101.5).

33. Method for installing a scaffold according to claim 32, wherein subsequently, the person (63) climbs up from the first vertical region (101.2, 101.3, 101.4) that has already been completed, in an interior space (83) of the scaffold (20) delimited by the first connecting rod (28.2) that serves as a hip and/or back railing element (62.1, 62.2) there, and by the horizontally adjacent vertical frame (25.2, 25.2) of this first vertical region (101.2, 101.3, 101.4), by way of the transverse rungs (35.4, 35.3) of the first ladder (21.1) or of the second ladder (21.2), to a floor plate (43) of the floor plates (43) of the said next, second vertical region (101.3, 101.4, 101.5), which region is already secured with the second connecting rod (28.2) that has already been affixed there previously and serves as a hip and/or back railing element (62.1, 62.2).

34. Method for installing a scaffold according to claim 32, wherein at least one floor plate (43) of the floor plates (43) of the first vertical region (101.2, 101.3, 101.4) that has already been completed is used during the set-up and for the set-up of the said next, second vertical region (101.3, 101.4, 101.5).

35. Method for installing a scaffold according to claim 32, wherein during the set-up and for the set-up of the said next, second vertical region (101.3, 101.4, 101.5), a person (63) standing on a floor plate (43) of the floor plates (43) of the first vertical region (101.2, 101.3, 101.4) that has already been completed removes another floor plate (43) of this first vertical region (101.2, 101.3, 101.4), and subsequently moves this other floor plate (43) upward, and there affixes it to an attachment position (61) for this other floor plate (43) that belongs to the first vertical region (101.2, 101.3, 101.4) that has already been completed, at a vertical distance of 80 cm to 120 cm or of about 100 cm below the hip and/or back railing of the second vertical region (101.3, 101.4, 101.5) formed by the second connecting rod (28.2).

36. Method for installing a scaffold according to claim 32, wherein during the set-up and for the set-up of the said next, second vertical region (101.3, 101.4, 101.5), all the other floor plates (43) of the first vertical region (101.2, 101.3, 101.4) that has already been completed are used, except for a single floor, plate (43) of the floor plates (43) of the first vertical region (101.2, 101.3, 101.4) that has already been completed.

37. Method for removing a scaffold, wherein the steps according to claim 32 are performed in the reverse order.
